(19) United States
(12) Patent Application Publication
(10) Pub. No.: US 2013/0144670 A1
(43) Pub. Date: Jun. 6, 2013

(54) SYSTEM AND METHOD FOR ALLOCATING RESOURCES IN A NETWORK

(71) Applicant: Joel Kickbusch, Melbourne, FL (US)

(72) Inventor: Joel Kickbusch, Melbourne, FL (US)

(21) Appl. No.: 13/311,977

(22) Filed: Dec. 6, 2011

(51) Int. Cl. G06Q 10/06

(52) U.S. Cl. 705/7.12

(57) ABSTRACT

A system includes first and second allocation units that allocate resources in a network according to respective first and second selected allocations for driving the resources toward a respective first or second goal conditions. At least one of the first or second allocation unit is configured to generate and provide feedback data to the other of the first or second allocation unit. The feedback data represents a difference between an actual allocation of the one or more resources and the corresponding first or second selected allocation. At least one of the first or second allocation unit is configured to change the corresponding first or second selected allocation to change how the resources are allocated in the network based on the feedback data.

### CROSS-REFERENCE TO RELATED APPLICATIONS

This application is related to co-pending U.S. patent application Ser. No. ______, which was filed on ______, is titled “Transportation Network Scheduling System And Method,” and is associated with Attorney Docket No. 251396 (552-0044) (referred to herein as the “______ application”), and U.S. patent application Ser. No. ______, which was filed on ______, is titled “Transportation Network Scheduling System And Method,” and is associated with Attorney Docket No. 251245 (552-049) (referred to herein as the “______ application”). The entire disclosures of the ______ application and the ______ application are incorporated by reference.

### BACKGROUND

Various networks of resources can have several systems that allocate the resources in different ways. The systems may allocate the resources in order for the systems to reach respective goals. Some of these systems may seek to allocate the resources in order to “optimize” (e.g., increase or decrease toward a quantifiable goal) the output or use of the resources. The end goals of these systems, however, may not coincide with each other. The allocation of the resources by a first system to reach a first goal may impede the allocation of the same resources by a second system to reach a different, second goal.

For example, scheduling systems for vehicles conveying cargo (such as trains) may seek to schedule the vehicles to arrive at scheduled destination locations no later than arrival times which also may be “optimized” to occur sooner rather than later. Another system, such as a management system that manages operations of one or more of the same vehicles, may seek to run the vehicle toward the scheduled destination location at a pace that reduces the fuel consumed or emissions generated by the vehicle. This may result in the vehicle traveling slower than desired by the scheduling system and may cause the vehicle to arrive at the scheduled destination location later than scheduled. Conversely, running the vehicle at a pace that causes the vehicle to arrive at the destination location no later than the scheduled arrival time may result in the vehicle consuming more fuel and/or generating more emissions than is desired by the management system. The allocation of the vehicles by these competing scheduling and management systems can result in one or both of the systems being prevented or impeded from reaching associated goals.

The deviation between the goal of the scheduling system or the management system and the actual movement of the vehicles may be greater for the scheduling system or management system than if the scheduling system or management system did not seek to reach an associated goal. Stated differently, the negative impact of competition between the systems in allocating the vehicles may be greater than if the systems did not compete with each other.

A need exists for systems and methods to harmonize the goals or allocations of common resources in a network by competing systems. Such systems and methods can improve overall performance of the resources or the network relative to allowing the competition between the systems to negatively impact all allocations of the systems.

### BRIEF DESCRIPTION

In one embodiment, a system is provided that includes a first allocation unit and a second allocation unit. As used herein, the terms “unit” or “module” include a hardware and/or software system that operates to perform one or more functions. For example, a unit or module may include one or more computer processors, controllers, and/or other logic-based devices that perform operations based on instructions stored on a tangible and non-transitory computer readable storage medium, such as a computer memory. Alternatively, a unit or module may include a hard-wired device that performs operations based on hard-wired logic of a processor, controller, or other device. In one or more embodiments, a unit or module includes or is associated with a tangible and non-transitory (e.g., not an electric signal) computer readable medium, such as a computer memory. The units or modules shown in the attached figures may represent the hardware that operates based on software or hardwired instructions, the computer readable medium used to store and/or provide the instructions, the software that directs hardware to perform the operations, or a combination thereof.

The first allocation unit is configured to allocate resources in a network (e.g., transportation network) according to a first selected allocation for driving the resources in the network toward a first goal condition of the first allocation unit. The second allocation unit is configured to allocate one or more of the resources in the network according to a different, second selected allocation for driving the one or more of the resources toward a different, second goal condition of the second allocation unit. At least one of the first allocation unit or the second allocation unit is configured to generate and provide feedback data to the other of the first allocation unit or the second allocation unit. The feedback data represents a difference between an actual allocation of the one or more resources and the corresponding first selected allocation or the second selected allocation. At least one of the first allocation unit or the second allocation unit is configured to change the first selected allocation or the second selected allocation to change how the resources are allocated in the network based on the feedback data.

In another embodiment, a method is provided that includes allocating resources in a network according to a first selected allocation for driving the resources in the network toward a first goal condition, allocating one or more of the resources in the network according to a different, second selected allocation for driving the one or more of the resources toward a different, second goal condition, and generating feedback data representative of a difference between an actual allocation of the one or more resources and the corresponding first selected allocation or the second selected allocation. The method also includes changing the first selected allocation or the second selected allocation of the resources in the network based on the feedback data.

In another embodiment, a system includes a first allocation unit that is configured to allocate resources in a network according to a first selected allocation for driving the resources in the network toward a first goal condition of the first allocation unit. The first allocation unit is configured to receive feedback data from a second allocation unit that is configured to allocate at least some of the resources in the network according to a different, second selected allocation for driving the at least some of the resources toward a different, second goal condition. The feedback data is representative of a difference between an actual allocation of the at least some of the resources and the second selected allocation. The first allocation unit also is configured to change at least one of the first selected allocation or the first goal condition based on the feedback data.

### BRIEF DESCRIPTION OF THE DRAWINGS

The present inventive subject matter will be better understood from reading the following description of non-limiting embodiments, with reference to the attached drawings, wherein below:

FIG. 1 is a schematic diagram of one embodiment of a resource allocation system for a network;

FIG. 2 is a schematic diagram of one embodiment of a transportation network;

FIG. 3 is a schematic illustration of one embodiment of a scheduling system shown in FIG. 2;

FIG. 4 is a schematic illustration of one embodiment of a yard planning system shown in FIG. 2;

FIG. 5 is a schematic illustration of one embodiment of a maintenance planning system shown in FIG. 2;

FIG. 6 is a schematic illustration of one embodiment of a vehicle shown in FIG. 2; and

FIG. 7 is a flowchart of one embodiment of a method for allocating resources in a network.

### DETAILED DESCRIPTION

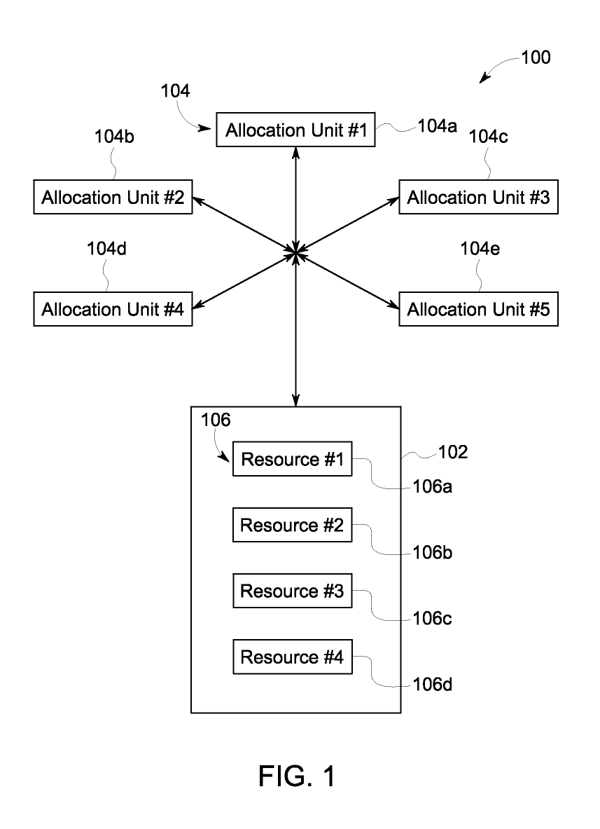

FIG. 1 is a schematic diagram of one embodiment of a resource allocation system 100 for a network 102. One or more embodiments of the inventive subject matter described herein provide systems and methods for synchronizing goal conditions among plural allocation units 104 (e.g., “Allocation Unit #1,” “Allocation Unit #2,” “Allocation Unit #3,” “Allocation Unit #4,” and “Allocation Unit #5”) that separately attempt to allocate at least some of the same resources 106 (e.g., “Resource #1,” “Resource #2,” “Resource #3,” and “Resource #4”) in the network 102 to reach different goal conditions. While five allocation units 104 and four resources 106 are shown, alternatively, a different number of the allocation units 104 and/or resources 106 may be used or present. As used herein, a “goal condition” may refer to a state of the network 102, such as the positions or locations of the resources 104 in the network 102, the throughput or flow of the resources 106 as the resources 106 move in the network 102, the usage of the resources 104 in the network 102, and the like. For example, a first goal condition of a first allocation unit 104a may be to have each of the resources 106 in the network 102 be located at designated positions or locations within the network 102. A different, second goal condition of a second allocation unit 104b may be to have one or more of the resources 106 in different designated positions or locations, or the same locations but at different times.

The allocation units 104 can use different algorithms to determine the steps, operations, and the like needed to drive (cause to move or trends towards) the resources 106 to the goal conditions associated with the allocation units 104. For example, the allocation units 104 can use one or more sets of instructions that calculate how the resources 106 are to be allocated (e.g., moved, used, and the like) in order to change the state of the network 102 from an initial state to the goal condition.

The network 102 can include or represent interconnected elements that are used by the resources 106 and that the allocation units 104 use to allocate the resources 106. As one example, a network 102 can be a transportation network formed from interconnected routes that vehicular resources (e.g., rail vehicles, other off-highway vehicles, automobiles, marine vessels, airplanes, and the like) travel on or along to move within the network 102. As another example, a network 102 can represent a financial network that includes various operations or functions (e.g., the interconnected elements) to which resources 106 (e.g., financial resources such as money) can be allocated. In another example, a network 102 can include a computer network having several interconnected routers (e.g., the interconnected elements) through which bandwidth (e.g., the resources 106 of the network 102) can be allocated to communicate data through the network. In another example, a network 102 can be a scheduling network that schedules available times among various users of the network, such as an airline reservation system, a hotel reservation system, a package delivery system, and the like. The inventive subject matter described herein also may apply to other examples of networks 102 in which resources 106 may be allocated, and the embodiments and examples provided herein are not intended to be limiting on all embodiments of the inventive subject matter.

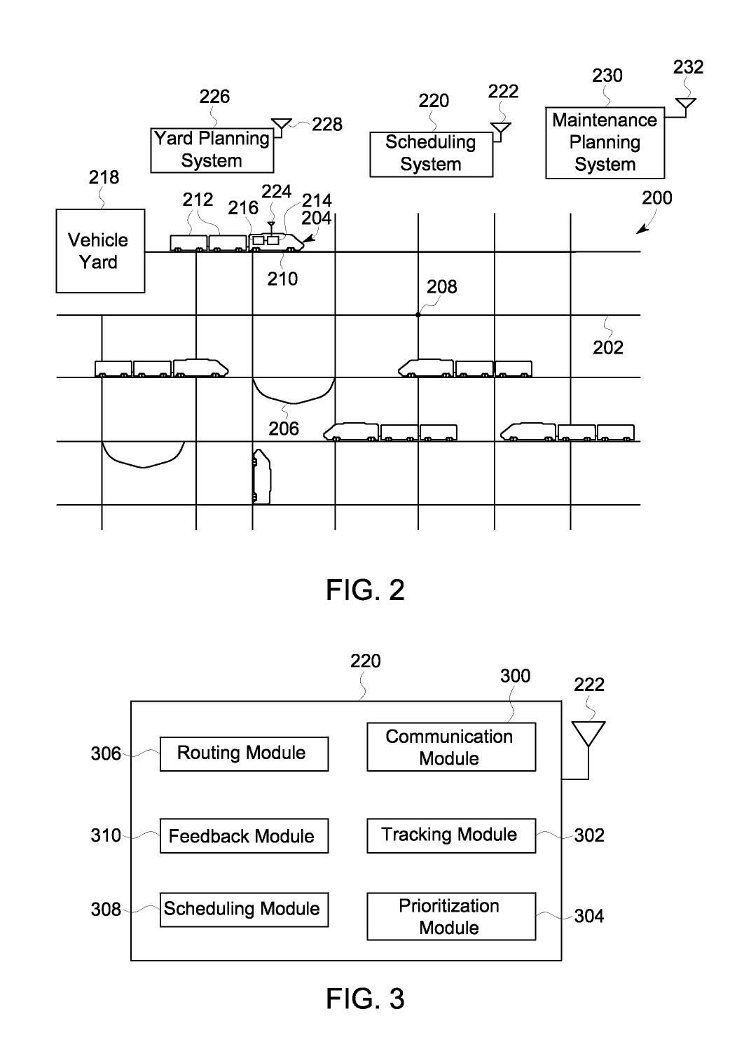

FIG. 2 is a schematic diagram of one embodiment of a transportation network 200. The transportation network 200 may be the network 102 (shown in FIG. 1). Alternatively, another type of network may be the network 102, as described above. The transportation network 200 includes a plurality of interconnected routes 202 over which vehicles 204 travel. In the illustrated embodiment, the routes 202 are tracks on which rail vehicles 204 travel. Alternatively, one or more of the vehicles 204 may be another off-highway vehicle, an automobile, a marine vessel, an airplane, and the like, and/or one or more of the routes 202 may be another path over which the vehicles 204 travel, such roads, marine shipping paths, airline paths, and the like. The transportation network 200 may extend over a relatively large area, such as hundreds of square miles or kilometers of land area. While the discussion herein focuses on rail vehicles 204, not all embodiments of the inventive subject matter described herein are limited to rail vehicles 204.

In the illustrated embodiment, the routes 202 include siding sections 206 that allow vehicles traveling along the same or opposite directions to pass each other. For example, a first vehicle 204 traveling in a first direction on a route 202 may pull off of the route 202 onto the siding section 206 to allow a different, second vehicle 104 traveling in an opposite second direction on the same route 202 to pass. As another example, the first vehicle 204 may pull off onto the siding section 206 to allow the second vehicle 204 traveling in the same direction to pass on the route 202. The routes 202 also include intersections 208 between different sections of the routes 202. The number of routes 202, siding sections 206, and intersections 208 shown in FIG. 2 is meant to be illustrative and not limiting on embodiments of the described subject matter.

Several of the vehicles 204 may concurrently travel along the routes 202 in the transportation network 200. In the illustrated embodiment, the vehicles 204 are shown and described herein as rail vehicles or rail vehicle consists. However, one or more other embodiments may relate to vehicles other than rail vehicles or rail vehicle consists. The term “vehicle” may refer to an individual component, such as an individual powered unit (e.g., a vehicle capable of self propulsion, such as a locomotive, marine vessel, airplane, automobile, off-highway vehicle, and the like), an individual non-powered unit (e.g., a vehicle incapable of self propulsion, such as a cargo or rail car or trailer), a group of powered and/or non-powered units mechanically and/or logically linked together (e.g., a consist, train, or the like). For example, a vehicle 204 may include a group of powered units 210 (e.g., locomotives or other vehicles capable of self-propulsion) and/or non-powered units 212 (e.g., cargo cars, passenger cars, or other vehicles incapable of self-propulsion) that are mechanically coupled or linked together to travel along the routes 202. The term “consist” may refer to a grouping or combination of plural vehicles into a larger vehicle, by mechanically linking the vehicles so that the grouping or combination of vehicles travels together as a motive unit.

In the illustrated embodiment, the vehicles 204 include control systems 214 and propulsion subsystems 216. The control systems 214 generate control signals that are used to direct operations of the vehicles 204. For example, a control system 214 on a vehicle 204 may create control signals that are used to automatically change throttle settings and/or brake settings of a propulsion subsystem 216 of the vehicle 204. Alternatively, the control system 214 can generate control signals that cause an output device, such as an electronic display, monitor, speaker, tactile device, or other device, to visually, audibly, and/or tactually present instructions to an operator of the vehicle 204 to manually change the throttle settings and/or brake settings. The propulsion subsystem 216 includes components that propel the vehicle 204, such as one or more engines, traction motors, and the like, and/or one or more components that slow, stop, or otherwise effect movement of the vehicle 204, such as one or more brakes (e.g., air brakes, dynamic brakes, and the like).

The transportation network 200 may include a vehicle yard 218. As used herein, the term “vehicle yard” can refer to a grouping of interconnected routes, such as interconnected railroad tracks, that are disposed relatively close to each other (e.g., disposed relatively close for a designated purpose relating to receiving vehicles for non-transitory layover). For example, the vehicle yard 218 can include routes 202 that are more densely packed relative to the density of the routes 202 outside of the vehicle yard 218. The vehicle yard 218 may be used to provide a variety of services to the vehicles 204. For example, a vehicle 204 may travel to the vehicle yard 218 to be stored (e.g., to end a current trip of the vehicle 204 and remain at the vehicle yard 218), for repair and/or maintenance of the vehicle 204, to obtain additional fuel, to unload cargo and/or cars off of the vehicle 204, to load cargo and/or add cars to the vehicle 204, to sort the vehicle 204 among other vehicles 204 (e.g., to rearrange an order of the vehicles 204 such that the vehicles leave the vehicle yard in a designated order), or the like. The vehicle yard 218 may act as a transportation hub in the transportation network 200, such as when the vehicle yard 218 is coupled with several routes 202 extending away from the vehicle yard 218 for the vehicles 204 to travel along to reach other destinations. The vehicle yard 218 may be a final destination of a trip of the vehicle 204, or may be an intermediate stopping off point when the vehicle 204 is traveling to another business destination (e.g., the destination to which the vehicle 204 is contracted to travel).

Several systems may allocate the vehicles 204 throughout the transportation network 200. In the illustrated embodiment, a scheduling system 220 may create schedules for the vehicles 204 that direct the vehicles 204 to travel to destination locations at corresponding scheduled arrival times. The schedules may include directions on which routes 202 that the vehicles 204 are to travel along in order to reach the scheduled destination locations. As described below, the scheduling system 220 may generate the schedules in order to coordinate travel of the vehicles 204 in the transportation network 200. The scheduling system 220 can represent one of the allocation units 104 shown in FIG. 1. For example, the scheduling system 220 can allocate the vehicles 204 in the transportation network 200 by directing how, when, and/or where the vehicles 204 travel in the transportation network 200. The scheduling system 220 can use various algorithms to determine how to create and coordinate the schedules of the vehicles 204. For example, different algorithms may be used by the scheduling system 220 to create the schedules, where the different algorithms use, consider, and/or weight different factors in order to create the schedules. The scheduling system 220 (or another system) may create, modify, and/or coordinate the schedules of the vehicles 204 according to a different, second algorithm, such as an algorithm that directs travel of the vehicles 204 so that overall throughput of the vehicles 204 is maintained above a designated, non-zero threshold. For example, the scheduling system 220 may seek to allocate movement of the vehicles 204 so that traffic jams or other significant slow downs or areas of congestion in the transportation network 200 are avoided.

The schedules can include movement events between two or more vehicles 204. A movement event includes coordinated travel of the two or more vehicles 204 at a location to avoid the vehicles 204 hitting each other or coming within a designated safety distance of each other. Examples of movement events include meet events, pass or overtake events, divergence events, and convergence events.

A meet event involves a first vehicle 204 and a second vehicle 204 concurrently traveling in opposite directions along the same route 202. The first vehicle 204 pulls off of the route 202 onto a siding section route 206 that is joined with the route 202 while the second vehicle 204 passes the first vehicle 204 on the route 202. Once the second vehicle 204 has passed, the first vehicle 204 may pull back onto the route 202 from the siding section route 206 and continue to travel along the route 202 in an opposite direction as the second vehicle 204.

A pass event involves a first vehicle 204 and a second vehicle 204 concurrently traveling in the same or a common direction along the same route 202. A pass event alternatively may be referred to as an overtake event or an overtaking event. The first vehicle 204 leads the second vehicle 204 along the route 202. The first vehicle 204 pulls onto a siding section 206 and allows the second vehicle 204 to pass on the route 202. The first vehicle 204 may then pull back onto the route 202 and follow the second vehicle 204.

A divergence event involves a first vehicle 204 and a second vehicle 204 concurrently traveling in the same direction on the same or a common route 202 that splits into two or more diverging routes 202 that head away from each other in different directions. The first vehicle 204 may lead the second vehicle 204 and may pull off of the common route 202 onto a first route 202 of the diverging routes 202. The second vehicle 204 may pull off of the common route 202 onto a different, second route 202 of the diverging routes 202 after the first vehicle 204 has pulled onto the first diverging route 202.

A convergence event involves a first vehicle 204 and a second vehicle 204 concurrently traveling on different routes 202 that converge into a common route 202, with the first and second vehicles 204 traveling toward the common route 202. The first vehicle 204 pulls onto the common route 202 ahead of the second vehicle 204 and the first and second vehicles 204 continue to travel in the same direction along the common route 202.

As shown in FIG. 2, the scheduling system 220 can be disposed off-board (e.g., outside) the vehicles 204. For example, the scheduling system 220 may be disposed at a central dispatch office for a railroad company. Alternatively, the scheduling system 220 can be disposed on-board one or more of the vehicles 204. The scheduling system 220 can create and communicate the schedules to the vehicles 204. For example, the scheduling system 220 can include a wireless antenna 222 (and associated transceiver equipment), such as a radio frequency (RF) or cellular antenna, that wirelessly transmits the schedules to wireless antennas 224 of the vehicles 204. The antennas 224 of the vehicles 204 may be communicatively coupled with the control systems 214 of the vehicles 204 to permit the control systems 214 to generate control signals that are used to control movement of the vehicles 204.

Another system that may allocate the vehicles 204 in the transportation network 200 is a yard planning system 226. The yard planning system 226 may determine which vehicles 204 are disposed in the vehicle yard 218, how long the vehicles 204 remain in the vehicle yard 218, which vehicles 218 are combined into a single vehicle 218 for travel in the transportation network 200, and the like. For example, the yard planning system 226 may determine which rail cars carrying cargo are included in a train that is scheduled to leave the vehicle yard 218 and travel to one or more destination locations. As described below, the yard planning system 226 may allocate the vehicles 204 in order to coordinate travel of the vehicles 204 in the transportation network 200. For example, the yard planning system 226 may control which vehicles 204 include one or more other vehicles 204 (e.g., rail cars) that are scheduled to leave the vehicle yard 218 and travel to a destination location. The yard planning system 226 can represent one of the allocation units 104 shown in FIG. 1. For example, the yard planning system 226 can allocate the vehicles 204 in the transportation network 200 by directing which vehicles 204 leave the vehicle yard 218 to enter the transportation network 200, when the vehicles 204 leave, and/or what other components (e.g., cargo) is carried by the vehicles 204.

The yard planning system 226 can use one or more algorithms to determine how to allocate usage of the vehicles 204 in the transportation network 200. For example, the yard planning system 226 can use a first algorithm that determines relative priorities between different vehicles 204, a second algorithm that determines destination locations of the vehicles 204 (e.g., from the scheduling system 220), a third algorithm that determines which vehicles 204 should be combined (e.g., when building a train, several vehicles 204 may be combined), a fourth algorithm that determines when the vehicles 204 leave the vehicle yard 218, and the like.

The yard planning system 226 can be disposed off-board the vehicles 204. Alternatively, the yard planning system 226 can be disposed on-board one or more of the vehicles 204. The yard planning system 226 can communicate with the vehicles 204 and/or the scheduling system 220. For example, the yard planning system 226 can include a wireless antenna 228 (and associated transceiving equipment), such as a radio frequency (RF) or cellular antenna, that wirelessly transmits the schedules to the antennas 224 of the vehicles 204 and/or the antenna 222 of the scheduling system 220. Alternatively, the yard planning system 226 may communicate with one or more of the vehicles 204 and/or scheduling system 220 using one or more wired connections.

Another system that may allocate the vehicles 204 in the transportation network 200 is a maintenance planning system 230. The maintenance planning system 230 may determine when and/or where one or more vehicles 204 and/or sections of the routes 202 are to be repaired and/or maintained. For example, the maintenance planning system 230 may schedule repair of vehicles 204 and/or routes 202, and may schedule services on the vehicles 204 and/or routes 202 to keep the vehicles 204 and/or routes 202 in good working order. The maintenance planning system 230 can represent one of the allocation units 104 shown in FIG. 1. For example, the maintenance planning system 230 can allocate the vehicles 204 in the transportation network 200 by directing which vehicles 204 are unavailable for use in the transportation network 200 and/or for how long the vehicles 204 are unavailable for use in the transportation network 200. As another example, the maintenance planning system 230 can allocate the routes 202 by directing which sections of the routes 202 and/or when the sections of the routes 202 are unavailable for use in the transportation network 202.

The maintenance planning system 230 can be disposed off-board the vehicles 204. Alternatively, the maintenance planning system 230 can be disposed on-board one or more of the vehicles 204. The maintenance planning system 230 can communicate with the vehicles 204, the scheduling system 220, and/or the yard planning system 226. For example, the maintenance planning system 230 can include a wireless antenna 232 (and associated transceiving equipment), such as a radio frequency (RF) or cellular antenna, that wirelessly transmits information concerning which vehicles 204 and/or sections of the routes 202 are unavailable to the antennas 224 of the vehicles 204, the antenna 222 of the scheduling system 220, and/or the antenna 228 of the yard planning system 226. Alternatively, the maintenance planning system 230 may communicate using one or more wired connections.

FIG. 3 is a schematic illustration of one embodiment of the scheduling system 220. The scheduling system 220 can include several modules that perform various operations described herein. The modules can represent one or more of the allocation units 104 shown in FIG. 1. For example, one or more of the modules of the scheduling system 220 can allocate the vehicles 204 (shown in FIG. 2) in the transportation network 200 (shown in FIG. 2) by directing movement of the vehicles 204 in order to achieve a goal condition of the vehicles 204. As described herein, two or more of the modules of the scheduling system 220 may have different goal conditions. For example, a first module of the scheduling system 220 may seek to allocate the vehicles 204 in a first state while a second module of the scheduling system 220 may seek to allocate the vehicles 204 in a different, second state. The modules shown in FIG. 3 may be communicatively coupled to communicate information between the modules, such as by being connected by wired and/or wireless connections.

The scheduling system 220 includes a communication module 300 that controls communication with the scheduling system 220. The communication module 300 may be communicatively coupled with the antenna 222 and/or a wired connection to transmit and/or receive information (e.g., in data packets) with the vehicles 204 (shown in FIG. 2), the yard planning system 226 (shown in FIG. 2), and the like.

The scheduling system 220 includes a tracking module 302 that monitors movement and/or positions of the vehicles 204 (shown in FIG. 2) in the transportation network 200 (shown in FIG. 2). The tracking module 302 may receive reports of current positions of the vehicles 204 from the vehicles 204. For example, the vehicles 204 may include position determining devices, such as Global Positioning System receivers, that provide geographic coordinates of where the vehicles 204 are located. The position determining devices can transmit these locations to the tracking module 302. Alternatively, one or more devices (e.g., wayside devices) may be disposed alongside the routes 202 (shown in FIG. 2). These devices may report when a vehicle 204 passes the devices to the tracking module 300. Based on known locations of these devices, the tracking module 302 can determine where various vehicles 204 are located in the transportation network 200.

The scheduling system 220 includes a prioritization module 304 that assigns priorities to the vehicles 204 (shown in FIG. 2). The prioritization module 304 may assign the priorities to the vehicles 204 to indicate which vehicles 204 take precedence over other vehicles 204 during travel within the transportation network 200 (shown in FIG. 2). For example, the priorities of the vehicles 204 may indicate which of the vehicles 204 should be scheduled to arrive at one or more destination locations earlier than other vehicles 204, which vehicles 204 take precedence when two or more vehicles 204 need to travel along the same section of one or more routes 202 (shown in FIG. 2), and the like. If two or more vehicles 204 need to travel to the same destination location (e.g., due to the vehicles 204 traveling according to legal contracts that require the vehicles 204 deliver cargo to the destination location), the vehicles 204 having higher priorities may have precedence to arrive at the destination location earlier than vehicles 204 with lower priorities. If two or more vehicles 204 need to travel over the same section of a route 202 at the same time, the vehicle 204 having a higher priority over another vehicle 204 may be permitted to travel over that section of the route 202 before the vehicle 204 with the lower priority. The priorities may be assigned from the prioritization module 304 based on manual input from an operator, from legal contracts associated with the shipping of cargo that is carried by the vehicles 204 (e.g., with vehicles 204 having contracts associated with greater financial value receiving higher priorities), from features of the vehicles 204 (e.g., longer, larger, and/or heavier vehicles 204 having higher priorities), and the like.

A routing module 306 of the scheduling system 220 determines the routes 202 (shown in FIG. 2) to be taken by the vehicles 204 (shown in FIG. 2) to reach associated destination locations. The routing module 306 may monitor which routes 202 are available for travel by the vehicles 204, and may keep track of which routes 202 or sections of the routes 202 are unavailable for travel due to repair, maintenance, damage, and the like. For example, an operator may input which sections of the routes 202 are unavailable for travel into the scheduling system 220. Although not shown in FIG. 2, the scheduling system 220 may be communicatively coupled with an input device, such as a keyboard, microphone, touchscreen, electronic mouse, joystick, or other device, to receive input from the operator. Alternatively, devices disposed along the routes 202, such as wayside devices, may monitor the health of the routes 202 and notify the scheduling system 220 when one or more sections of the routes 202 are unavailable for travel.

In one embodiment, the routing module 306 creates paths over the routes 202 (shown in FIG. 2) that are to be taken by the vehicles 204 (shown in FIG. 2) so that the vehicles 204 travel to the destination locations over a smaller distances than if the vehicles 204 took one or more other routes 202. For example, the routing module 306 may determine a shorter path or the shortest path between the starting location and the destination location of the vehicle 204 than one or more other paths that the vehicle 204 may take to the destination location. The routing module 306 may determine if the paths of two or more vehicles 204 (shown in FIG. 2) cross each other and/or overlap each other. For example, the routing module 306 may identify a potential conflict when two or more vehicles 204 are to travel over paths that cross and/or are at least partially coextensive with each other.

A scheduling module 308 of the scheduling system 220 creates and/or modifies the schedules of the vehicles 204 (shown in FIG. 2). The scheduling module 308 may communicate with one or more other modules, such as the tracking module 302, the prioritization module 304, and/or the routing module 306 to form the schedules. For example, the scheduling module 308 may confer with the tracking module 302 to determine a current location of a vehicle 204. The scheduling module 308 can communicate with the prioritization module 304 to determine which vehicles 204 have higher priorities than other vehicles 204. The scheduling module 308 may receive paths and/or potential conflicts between vehicles 204 from the routing module 306. The scheduling module 308 can then generate the schedules so that the vehicles 204 with higher priorities travel and arrive at destination locations before vehicles 204 with lower priorities. The scheduling module 308 can include movement events to avoid collisions between vehicles 204 and/or to prevent the vehicles 204 from coming too close to each other.

One or more of the modules of the scheduling system 220 can use algorithms to assign priorities to the vehicles 204 (shown in FIG. 2), determine routes for the vehicles 204, and the like. With respect to the prioritization module 304, different algorithms may be used to assign the priorities based on one or more factors, such as the financial value of the cargo carried by the vehicles 204, the size and/or weight of the vehicles 204, the type of vehicles 204 (e.g., the amount of tractive effort the vehicles 204 are capable of providing, the age of the vehicles 204, and the like), the financial values of contracts under which the vehicles 204 transport cargo, and the like. The priorities may differ based on which algorithm is used. For example, a first algorithm may assign higher priorities to the vehicles 204 carrying cargo under more valuable shipping contracts while a second algorithm may assign higher priorities to the larger vehicles 204 (e.g., to keep the larger vehicles 204 moving in the transportation network 200 and avoid creating traffic jams or otherwise decreasing the flow of movement in the transportation network).

With respect to the routing module 306, different algorithms may be used to determine the routes 202 (shown in FIG. 2) to be taken by different vehicles 204 (shown in FIG. 2) to the scheduled destination locations. The different algorithms may determine the routes 202 for the vehicles 204 based on one or more factors, such as the size and/or weight of the vehicles 204, the type of vehicles 204, the distance to be traveled by the vehicles 204, and the like. The different algorithms may generate determine different routes 202 for the same vehicle 204 based on the different factors. For example, a first algorithm may determine paths for vehicles 204 based primarily on the distances that the vehicles 204 travel to the scheduled destination locations. A different, second algorithm may determine different paths for the same vehicles 204 based on the size and/or weight of the vehicles 204.

The scheduling module 308 communicates the schedules to the vehicles 204 (shown in FIG. 2) using the communication module 300. The vehicles 204 receive the schedules and travel in the transportation network 200 (shown in FIG. 2) according to the schedules. In one embodiment, the tracking module 302 monitors the actual movements of the vehicles 204 to determine how closely the travel of the vehicles 204 is to the schedules created by the scheduling module 308. The tracking module 302 can determine one or more throughput parameters for the transportation network 200 based on how closely the vehicles 204 adhere to the schedules. A throughput parameter can represent the flow or movement of the vehicles 204 through the transportation network 200 or a portion of the transportation network 200. The throughput parameter can be a statistical measure of adherence by one or more of the vehicles 204 to the schedules of the vehicles 204. The term “statistical measure of adherence” can refer to a numerical quantity that is calculated for a vehicle 204 and that indicates how closely the vehicle 204 is following the schedule associated with the vehicle 204. Several statistical measures of adherence to the schedules may be calculated for the vehicles 204 traveling in the transportation network 200.

A larger throughput parameter may represent greater flow of the vehicles 204 (shown in FIG. 2) through the transportation network 200 (shown in FIG. 2), such as what may occur when a relatively large percentage of the vehicles 204 adhere to the associated schedules and/or the amount of congestion in the transportation network 200 is relatively low. Conversely, smaller throughput parameters may represent reduced flow of the vehicles 204 through the transportation network 200. The throughput parameter may reduce in value when a lower percentage of the vehicles 204 follow the associated schedules and/or the amount of congestion in the transportation network 200 is relatively large.

The scheduling module 308 can create the schedules of the vehicles 204 (shown in FIG. 1) prior to sending the schedules to the vehicles 204 such that one or more throughput parameters of the vehicles 204 are expected to be maintained above a predetermined non-zero threshold. For example, the scheduling module 308 can coordinate the schedules such that the expected movements of the vehicles 204 according to the schedules avoids or prevents a congestion (e.g., density per unit area over a time window) of the vehicles 204 in one or more portions of the transportation network 200 from exceeding a designated threshold.

Once the vehicles 204 (shown in FIG. 2) are moving according to the schedules, the tracking module 302 may calculate the throughput parameter of the transportation network 200 (shown in FIG. 2) as the vehicles 204 travel. The throughput parameter based on differences the schedules of the vehicles 204 and actual locations and associated times of the vehicles 204. An estimated time of arrival (ETA) of a vehicle 204 may be calculated by the tracking module 302 as the time that the vehicle 204 will arrive at the scheduled destination if no additional anomalies occur that change the speed at which the vehicle 204 travels. If the ETAs are the same as or within predetermined time windows of the scheduled arrival times, then the tracking module 302 may calculate a relatively large statistical measure of adherence for the vehicles 204 and/or a relatively large throughput parameter. As the ETA differs from the scheduled arrival time (e.g., by occurring after the scheduled arrival time), the statistical measure of adherence and/or throughput parameter may decrease.

Alternatively, the tracking module 302 may calculate the throughput parameter by determining how many scheduled waypoints that the vehicles 204 (shown in FIG. 2) travel through or past within a predetermined time buffer of scheduled times that the vehicles 204 are scheduled to travel through or past the waypoints. As differences between actual times that the vehicles 204 arrive at or pass through the scheduled waypoints and the associated scheduled times of the waypoints increases, the statistical measures of adherence of the vehicles 204 and/or the throughput parameter of the transportation network 200 may decrease.

The tracking module 208 may calculate the statistical measure of adherence as a time difference between the ETA of a vehicle 108 (shown in FIG. 1) and the scheduled arrival time of the schedule associated with the vehicle 108. Alternatively, the statistical measure of adherence for the vehicle 108 may be a fraction or percentage of the scheduled arrival time. For example, the statistical measure of adherence may be the fraction or percentage that the difference between the ETA and the scheduled arrival time is of the scheduled arrival time. In another example, the statistical measure of adherence may be a number of scheduled waypoints in a schedule of the vehicle 108 that the vehicle 108 arrives at or passes by later than the associated scheduled time or later than a time window after the scheduled time. Alternatively, the statistical measure of adherence may be a sum total, average, median, or other calculation of time differences between the actual times that the vehicle 108 arrives at or passes by scheduled waypoints and the associated scheduled times.

The tracking module 302 may determine the throughput parameter for the transportation network 200 (shown in FIG. 2), or a subset thereof, based on the statistical measures of adherence associated with the vehicles 204 (shown in FIG. 2). For example, a throughput parameter may be an average, median, or other statistical calculation of the statistical measures of adherence for the vehicles 204 concurrently traveling in the transportation network 200. The throughput parameter may be calculated based on the statistical measures of adherence for all, substantially all, a supermajority, or a majority of the vehicles 204 traveling in the transportation network 200. Table 1 below provides examples of statistical measures of adherence of a vehicle 204 to an associated schedule in a movement plan. Table 1 includes four columns and seven rows. Table 1 represents at least a portion of a schedule of the vehicle 204. Several tables may be calculated for different schedules of different vehicles 204 in the movement plan for the transportation network 200. The first column provides coordinates of scheduled locations that the vehicle 204 is to pass through or arrive at the corresponding scheduled times shown in the second column. The coordinates may be coordinates that are unique to a transportation network 200 or that are used for several transportation networks (e.g., Global Positioning System coordinates). The numbers used for the coordinates are provided merely as examples. Moreover, information regarding the scheduled location other than coordinates may be used.

TABLE 1

| Scheduled Location | | | |
|---|---|---|---|
| (SL) | Scheduled Time | Actual Time at SL | Difference |
| (123.4, 567.8) | 09:00 | 09:00 | 0 |
| (901.2, 345.6) | 09:30 | 09:33 | (0:03) |
| (789.0, 234.5) | 10:15 | 10:27 | (0:12) |
| (678.9, 345.6) | 10:43 | 10:44 | (0:01) |
| (987.6, 543.2) | 11:02 | 10:58 | 0:04 |
| (109.8, 765.4) | 11:15 | 11:14 | 0:01 |
| (321.0, 987.5) | 11:30 | 11:34 | (0:04) |

The third column includes a list of the actual times that the vehicle 204 (shown in FIG. 2) arrives at or passes through the associated scheduled location. For example, each row in Table 1 includes the actual time that the vehicle 204 arrives at or passes through the scheduled location listed in the first column for the corresponding row. The fourth column in Table 1 includes a list of differences between the scheduled times in the second column and the actual times in the third column for each scheduled location.

The differences between when the vehicle 204 (shown in FIG. 2) arrives at or passes through one or more scheduled locations and the time that the vehicle 204 was scheduled to arrive at or pass through the scheduled locations may be used to calculate the statistical measure of adherence to a schedule for the vehicle 204. In one embodiment, the statistical measure of adherence for the vehicle 204 may represent the number or percentage of scheduled locations that the vehicle 204 arrived too early or too late. For example, the tracking module 302 may count the number of scheduled locations that the vehicle 204 arrives at or passes through outside of a time buffer around the scheduled time. The time buffer can be one to several minutes. By way of example only, if the time buffer is three minutes, then the tracking module 302 may examine the differences between the scheduled times (in the second column of Table 1) and the actual times (in the third column of Table 1) and count the number of scheduled locations that the vehicle 108 arrived more than three minutes early or more than three minutes late.

Alternatively, the tracking module 302 may count the number of scheduled locations that the vehicle 204 (shown in FIG. 2) arrived early or late without regard to a time buffer. With respect to Table 1, the vehicle 204 arrived at four of the scheduled locations within the time buffer of the scheduled times, arrived too late at two of the scheduled locations, and arrived too early at one of the scheduled locations.

The tracking module 302 may calculate the statistical measure of adherence by the vehicle 204 (shown in FIG. 2) to the schedule based on the number or percentage of scheduled locations that the vehicle 204 arrived on time (or within the time buffer). In the illustrated embodiment, the tracking module 302 can calculate that the vehicle 204 adhered to the schedule (e.g., remained on schedule) for 57% of the scheduled locations and that the vehicle 204 did not adhere (e.g., fell behind or ahead of the schedule) for 43% of the scheduled locations.

Alternatively, the tracking module 302 may calculate the statistical measure of adherence by the vehicle 204 (shown in FIG. 2) to the schedule based on the total or sum of time differences between the scheduled times associated with the scheduled locations and the actual times that the vehicle 204 arrived at or passed through the scheduled locations. With respect to the example shown in Table 1, the tracking module 302 may sum the time differences shown in the fourth column as the statistical measure of adherence. In the example of Table 1, the statistical measure of adherence is −15 minutes, or a total of 15 minutes behind the schedule of the vehicle 204.

In another embodiment, the tracking module 302 may calculate the average statistical measure of adherence by comparing the deviation of each vehicle 204 (shown in FIG. 2) from the average or median statistical measure of adherence of the several vehicles 204 traveling in the transportation network 200 (shown in FIG. 2). For example, the tracking module 302 may calculate an average or median deviation of the measure of adherence for the vehicles 204 from the average or median statistical measure of adherence of the vehicles 204.

The tracking module 302 can determine the throughput parameter of the transportation network 200 (shown in FIG. 2) based on the statistical measures of adherence for a plurality of the vehicles 204 (shown in FIG. 2). For example, the tracking module 302 may calculate the throughput parameter based on the statistical measure of adherence for all, substantially all, a supermajority, or a majority of the vehicles 204 traveling in the transportation network 200. In one embodiment, the tracking module 302 calculates an average or median of the statistical measures of adherence for the vehicles 204 traveling in the transportation network 200 as the throughput parameter. However, the throughput parameter may be calculated in other ways. The throughput parameter can measured as an average or median rate of throughput or rate of travel through the transportation network 200, such as an average or median rate at which the vehicles 204 travel according to the associated schedules.

As described above, the scheduling system 220 may attempt to allocate (e.g., move) the vehicles 204 (shown in FIG. 2) in the transportation network 200 (shown in FIG. 2) to get the vehicles 204 to associated destination locations at scheduled arrival times. The goal condition of the scheduling system 220 may be getting the vehicles 204 in a spatial arrangement (e.g., the vehicles 204 at the associated destination locations) and/or a temporal arrangement (e.g., the vehicles 204 at the destination locations at associated scheduled arrival times). Other systems that allocate the vehicles 204 in the transportation network 200, however, may allocate the vehicles 204 differently and in a manner that prevents the vehicles 204 from being allocated as the scheduling system 220 attempts to allocate the vehicles 204. As a result, the actual allocation (e.g., locations and/or times at which the vehicles 204 are at the locations) may differ from the scheduled allocation determined by the scheduling system 220.

A feedback module 310 of the scheduling system 220 can determine deviations or differences between the actual allocation of the vehicles 204 (shown in FIG. 2) and the scheduled allocation of the vehicles 204. For example, at the times that the vehicles 204 are scheduled to be at one or more locations, the feedback module 310 may determine actual locations of the vehicles 204 from the tracking module 302 and compare the actual locations to the scheduled locations. The difference between the actual locations and the scheduled locations may represent differences between the actual allocation and the scheduled allocation of the vehicles 204. For example, the scheduling system 220 can generate the schedules for the vehicles 204 in order to get higher priority vehicles 204 to destination locations before lower priority vehicles 204, in order to maintain the throughput parameter of the transportation network 200 (shown in FIG. 2), in order to reduce congestion or traffic jams between the vehicles 204, and the like. However, as stated above, other systems (e.g., allocation units 104 shown in FIG. 1) may allocate at least some of the same vehicles 204 differently than the scheduling system 220. As a result, the different allocations may cause the actual movement of the vehicles 204 to differ from the schedules established by the scheduling system 220.

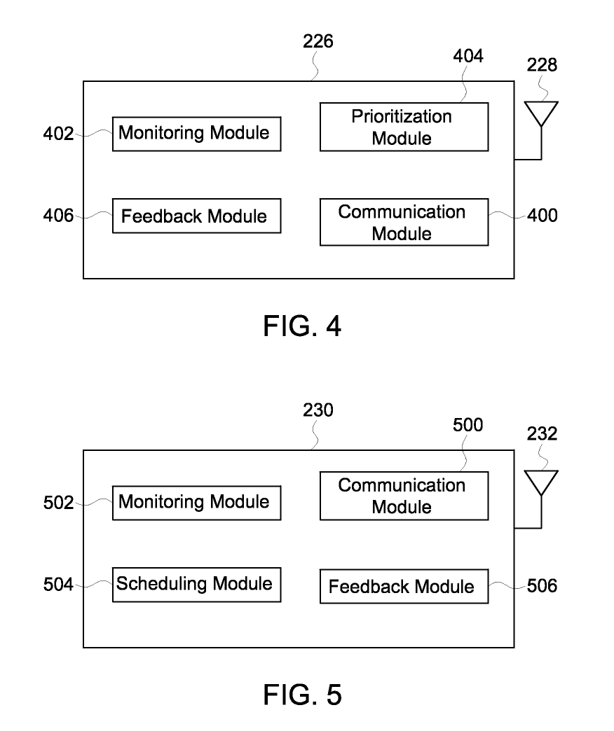

FIG. 4 is a schematic illustration of one embodiment of the yard planning system 226. Similar to the scheduling system 220 shown in FIG. 3, the yard planning system 226 can include several modules that perform various operations described herein. The modules can represent one or more of the allocation units 104 shown in FIG. 1. As described herein, two or more of the modules of the yard planning system 226 may have different goal conditions than each other, and/or different goal conditions than one or more modules of the scheduling system 220.

The yard planning system 226 includes a communication module 400 that controls communication with the yard planning system 226. In one embodiment, the communication module 400 may be similar to the communication module 300 (shown in FIG. 3) of the scheduling system 220 (shown in FIG. 2). For example, the communication module 400 can be communicatively coupled with the antenna 228 and/or a wired connection to transmit and/or receive information (e.g., in data packets).

The yard planning system 226 includes a monitoring module 402 that monitors the vehicles 204 (shown in FIG. 2) in the vehicle yard 218 (shown in FIG. 2). The monitoring module 402 may receive reports of current positions of the vehicles 204 in the vehicle yard 218 from the vehicles 204, as provided by an operator using an input device coupled with the yard planning system 226, or from another source. The monitoring module 402 can track which vehicles 204 are coupled with each other, such as with trains. In one embodiment, the monitoring module 402 can monitor times that the vehicles 204 are scheduled to leave the vehicle yard 218. For example, the monitoring module 402 can receive schedules or scheduled times of departure from the vehicle yard 218 via the communication module 400 and from the scheduling system 220.

The yard planning system 226 includes a prioritization module 404 that assigns priorities to the vehicles 204 (shown in FIG. 2). The prioritization module 404 may assign the priorities to the vehicles 204 to indicate which vehicles 204 take precedence over other vehicles 204 in the vehicle yard 218. For example, the priorities assigned to the vehicles 204 may be used in determining when the vehicles 204 are able to leave the vehicle yard 218, which vehicles 204 receive services in the vehicle yard 218 before other vehicles 204, which vehicles 204 are combined (e.g., coupled or linked) together into a larger vehicle 204 to leave the vehicle yard 218, where the vehicles 204 are located in the vehicle yard 218, and the like.

The prioritization module 404 may use the priorities assigned to the vehicles 204 (shown in FIG. 2) to allocate the vehicles 204 for travel in the transportation network 200 (shown in FIG. 2). For example, the prioritization module 404 can assign priorities to the vehicles 204 to control which vehicles 204 leave the vehicle yard 218 (shown in FIG. 2) for travel in the transportation network 200, when the vehicles 204 leave the vehicle yard 218, and/or which vehicles 204 are combined with each other to form larger vehicles 204. As described above, the priorities between the vehicles 204 can determine which vehicles 204 receive services before other vehicles 204, and therefore are able to leave the vehicle yard 218 before other vehicles 204 still waiting for services in the vehicle yard 218. The priorities can be used to determine where the vehicles 204 are located in the vehicle yard 218. Those vehicles 204 located closer to an exit of the vehicle yard 218 (e.g., a portion of the vehicle yard 218 that is coupled with a route 202 shown in FIG. 2 of the transportation network 200) may be able to leave the vehicle yard 218 before other vehicles 204 that are not located at or near the exit. The priorities may be used to determine which vehicles 204 are combined, such as by combining several higher priority vehicles 204 with each other to form a vehicle consist (such as a train). The higher priority combined vehicles 204 may then travel together as a unit through the transportation network 200 ahead of other, lower priority vehicles 204. The above uses of assigning priorities to the vehicles 204 can be used to allocate the vehicles 204 such that the higher priority vehicles 204 leave the vehicle yard 218 before other vehicles 204.

However, the allocation of the vehicles 204 (shown in FIG. 2) by the prioritization module 404 of the yard planning system 226 may differ from the allocation of the vehicles 204 by the scheduling system 220 (shown in FIG. 2). For example, the prioritization module 404 may assign a relatively high priority to a first vehicle 204 that is to be coupled with at least a second vehicle 204 in order to form a larger combined vehicle 204 (e.g., a vehicle consist such as a train) that is assigned a relatively low priority from the scheduling system 220. The high priority of the first vehicle 204 that is assigned from the yard planning system 226 may cause the first and second vehicles 204 to be combined with each other, receive services in the vehicle yard 218 (shown in FIG. 2) before other vehicles 204, and/or be positioned to leave the vehicle yard 218 before the other vehicles 204. In contrast, the low priority of the combined vehicle 204 (that includes the first vehicle 204) that is assigned by the scheduling system 220 may result in the combined vehicle 204 being scheduled to leave the vehicle yard 218 after one or more lower priority vehicles 204, moving slower in the transportation network 200 just outside of the vehicle yard 218, or otherwise interfering with the travel of vehicles 204 having higher priorities from the scheduling system 220. As a result, the combined vehicle 204 may be forced by the scheduling system 220 to wait in the vehicle yard 218 after the combined vehicle 204 is built (e.g., formed by the first and second vehicles 204) until after other vehicles 204 having higher priorities from the scheduling system 220 leave the vehicle yard 218.

In another example, the prioritization module 404 may assign a relatively low priority to the first vehicle 204 (shown in FIG. 2) that is to be coupled with at least the second vehicle 204 in order to form the combined vehicle 204 that is assigned a relatively high priority from the scheduling system 220 (shown in FIG. 2). The low priority of the first vehicle 204 that is assigned from the yard planning system 226 may cause the combined vehicle 204 (that includes the first vehicle 204) to receive services in the vehicle yard 218 (shown in FIG. 2) after other vehicles 204 and/or be positioned to leave the vehicle yard 218 after the other vehicles 204. In contrast, the high priority of the combined vehicle 204 that is assigned by the scheduling system 220 may result in the combined vehicle 204 being scheduled to leave the vehicle yard 218 before one or more lower priority vehicles 204 and/or being scheduled to move ahead of and/or faster in the transportation network 200 just outside of the vehicle yard 218 than other vehicles 204. As a result, the combined vehicle 204 may be forced by the yard planning system 226 to fall behind schedule because the combined vehicle 204 exits the vehicle yard 218 after and/or behind lower priority vehicles 204.

The assignment of priorities by the prioritization module 404 may be performed using one or more algorithms. The algorithms may assign the priorities based on one or more factors, such as the financial value of the cargo carried by the vehicles 204 (shown in FIG. 2), the size and/or weight of the vehicles 204, the type of vehicles 204 (e.g., the amount of tractive effort the vehicles 204 are capable of providing, the age of the vehicles 204, and the like), similarities with other vehicles 204 (e.g., with higher priorities assigned to vehicles 204 that are scheduled to travel to the same or nearby destination locations), the financial values of contracts under which the vehicles 204 transport cargo, and the like. Different algorithms of the prioritization module 404 may use different factors and/or assign different weights to the factors. For example, a first algorithm may give greater weight in assigning priorities to the financial values of the contracts associated with the vehicles 204 while a second algorithm may give greater weight to the similarities between the vehicles 204. Different algorithms may create different allocations of the vehicles 204.

FIG. 5 is a schematic illustration of one embodiment of the maintenance planning system 230. Similar to the scheduling system 220 and/or the yard planning system 226 shown in FIGS. 3 and 4, the maintenance planning system 230 can include several modules that perform various operations described herein. The modules can represent one or more of the allocation units 104 shown in FIG. 1. As described herein, two or more of the modules of the maintenance planning system 230 may have different goal conditions than one or more modules of the scheduling system 220 and/or the yard planning system 226.

The maintenance planning system 230 includes a communication module 500 that controls communication with the maintenance planning system 230. In one embodiment, the communication module 500 may be similar to the communication module 300 (shown in FIG. 3) of the scheduling system 220 (shown in FIG. 2) and/or the communication module 400 (shown in FIG. 4) of the yard planning system 226 (shown in FIG. 2) to control communication between the maintenance planning system 230 and one or more of the scheduling system 220, the yard planning system 226, and/or the vehicles 204 (shown in FIG. 2).

The maintenance planning system 230 includes a monitoring module 502 that monitors health of the vehicles 204 (shown in FIG. 2) and/or sections of the routes 202 (shown in FIG. 2) in the transportation network 200 (shown in FIG. 2). In order to monitor the health of the vehicles 204 and/or routes 202, the monitoring module 502 may track an age and/or amount of time in service of the vehicles 204 and/or sections of the route 202. The amount of time in service can represent the amount of time that the vehicles 204 have been used to travel and/or the amount of time since the sections of the routes 202 were installed or built. The monitoring module 502 can monitor performance of the vehicles 204 and/or sections of the routes 202 as indicative of the health of the vehicles 204 and/or routes 202. For example, the monitoring module 502 can receive information related to the health of the vehicles 204 from wayside devices (e.g., hot box detectors), sensors disposed on the vehicles 204 (e.g., sensors that monitor tractive output, braking efforts, engine temperatures, amounts of wheel slip, and the like, of the vehicles 204), and/or from operators (e.g., humans who inspect the vehicles 204). The monitoring module 502 can receive information related to the health of the routes 202 from wayside devices (e.g., switching mechanisms that also may monitor performance of the switch and/or routes 202), sensors on the vehicles 204 (e.g., sensors that monitor vibration of the routes 202), and/or from operators (e.g., humans who inspect the routes 202).

Depending on the health of the vehicles 204 (shown in FIG. 2) and/or routes 202 (shown in FIG. 2), a scheduling module 504 of the maintenance planning module 230 may schedule services for one or more of the vehicles 204 and/or sections of the routes 202. For example, if the health of a vehicle 204 and/or section of a route 202 indicates that the vehicle 204 and/or route 202 is in need of repair or maintenance for continued operation of the vehicle 204 and/or route 202. The scheduling module 504 may assign a time and/or location for repair and/or maintenance of the vehicles 204 and/or routes 202, such as the location of the vehicle yard 218 (shown in FIG. 2) for the vehicles 204 or the location of a damaged portion of the routes 202.

In one embodiment, the scheduling module 504 uses one or more algorithms that may allocate the vehicles 204 (shown in FIG. 2) and/or the sections of the routes 202 (shown in FIG. 2) for repair and/or maintenance differently. For example, a first algorithm may schedule a vehicle 204 in need of repair and/or maintenance for services at an earlier time than a different, second algorithm would. The first algorithm may seek to allocate the vehicles 204 and/or routes 202 for repair and/or maintenance at relative early times, such as an earliest possible time, while the second algorithm may seek to allocate the vehicles 204 and/or routes 202 for repair based on another factor, such as distances between the vehicles 204 and repair facilities (e.g., the vehicle yard 218 shown in FIG. 2), distances between the sections of the routes 202 needing service and resources that repair or maintain the routes 202, priorities assigned to the vehicles 204 by the scheduling system 220 and/or yard planning system 226 shown in FIG. 2 (e.g., with the repair of higher priority vehicles 204 being scheduled prior to the repair of lower priority vehicles 204), and the like.

A feedback module 506 of the maintenance planning system 226 can determine deviations or differences between the assigned allocation of the vehicles 204 (shown in FIG. 2) and/or routes 202 (shown in FIG. 2) for repair and/or maintenance by the scheduling module 504 and the actual allocation of the vehicles 204 and/or routes 202 for repair. For example, the scheduling module 504 may schedule a vehicle 204 for repair at the same time that the scheduling system 220 (shown in FIG. 2) schedules the vehicle 204 to be traveling in the transportation network 200 (shown in FIG. 2). As another example, the scheduling module 504 may schedule a section of a route 202 for repair at the same time that the scheduling system 220 schedules one or more vehicles 204 to travel over the section of the route 202. Due to conflicts with other systems, the time and/or location for repair and/or maintenance that is selected by the scheduling module 504 may be unavailable. As a result, the actual time and/or location of the repair and/or maintenance may be different from the assigned or selected allocation of the vehicle 204 and/or route 202 for repair and/or maintenance.

The feedback module 506 determines such differences between the actual and assigned allocation of the vehicles 204 (shown in FIG. 2) and/or routes 202 (shown in FIG. 2) for repair and/or maintenance. For example, the feedback module 506 may calculate the differences in time and/or location between the actual repair and the assigned time and/or location for repair.

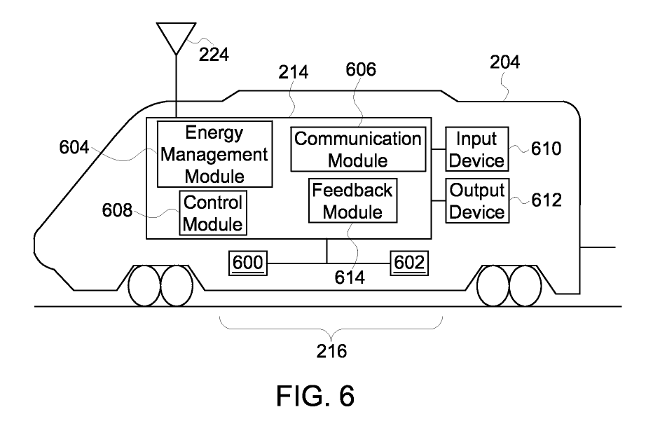

FIG. 6 is a schematic illustration of one embodiment of one of the vehicles 204. Several components of the vehicle 204 are shown in FIG. 6 as being connected with each other. The connections between the components are meant to represent operative or communication connections between the components. For example, the connections may represent wired and/or wireless connections, such as busses, wires, network connections, and the like. Alternatively, a connection between two or more of the components may be eliminated and the components may be included in a single component or device. As described above, the vehicle 204 includes the control system 214, which is communicatively coupled with the propulsion subsystem 216 of the vehicle 204. The propulsion subsystem 216 can include one or more motive assemblies 600 and/or one or more braking assemblies 602. The motive assembly 600 shown in FIG. 6 may include or represent an engine, alternator and/or generator, motors, and the like, that convert fuel into tractive effort used to propel the vehicle 204. Alternatively, the motive assembly 600 may include or represent one or more motors that receive electric current from an off-board source, such as an electrified rail and/or overhead catenary, to propel the vehicle 204. The braking assembly 602 may include or represent one or more brakes, such as air brakes, dynamic brakes, and the like.

The control system 214 includes a communication module 606 that controls communication with the control system 214. The communication module 606 may be similar to one or more of the communication modules 300, 400, 500 shown in FIGS. 3, 4, and 5, to permit communication between the vehicle 204 and one or more of the scheduling system 220, the yard planning system 226, the maintenance planning system 230, and/or other vehicles 204.

The control system 214 includes an energy management module 604 that forms trip plans for the vehicle 204 that are used to control operations of the propulsion subsystem 216 during trips of the vehicle 204. A trip of the vehicle 204 includes the travel of the vehicle 204 along the routes 204 from a starting location to a destination location. The trip plans dictate how the vehicle 204 should be operated to travel to the destination location. For example, a trip plan can include designated speeds, throttle settings, brake settings, and the like, for a vehicle 204 during various segments of a trip.

In one embodiment, the trip plan is formed by the control system 214 to reduce an amount of energy (e.g., fuel) that is consumed by the vehicle 204 and/or to reduce an amount of emissions generated by the vehicle 204 over the course of the trip. Following the trip plan can cause the vehicle 204 to be propelled to the scheduled destination location in a manner that consumes less energy (e.g., fuel) and/or produces fewer emissions than if the vehicle 204 traveled to the scheduled destination location in another manner (e.g., not using the speeds, throttle settings, and/or brake settings of the trip plan). As one example, the vehicle 204 may consume less fuel and/or produce fewer emissions in traveling to the destination location according to the trip plan than if the vehicle 204 traveled to the same destination location while traveling without using the trip plan, such as by traveling at another predetermined speed (e.g., a speed limit of the routes 202, which may be referred to as “track speed”).

The trip plan may be an allocation of resources in the transportation network 200 (shown in FIG. 2) as described above in connection with the allocation units 104 shown in FIG. 1. For example, the energy management module 604 may allocate the tractive efforts and/or braking efforts of the vehicle 204 to move in the transportation network 200. The energy management module 604 may use one or more algorithms to generate the trip plan. For example, a first algorithm may generate a trip plan that seeks to reduce the amount of fuel consumed by the vehicle 204 in traveling to a destination location while a different, second algorithm may generate s different trip plan that seeks to cause the vehicle 204 to arrive at a destination location (e.g., as set by the scheduling system 220 shown in FIG. 2) in less time than the trip plan of the first algorithm, while reducing emissions of the vehicle 204.

In one embodiment, the energy management module 604 includes a software application or system such as the Trip Optimizer™ system provided by General Electric Company. The energy management module 604 can use trip data, vehicle data, route data, and/or an update to trip data, vehicle data, or route data to form the trip plan for the vehicle 204.

Trip data can include information about the path taken by the vehicle 204 to travel to a scheduled destination location. By way of example, trip data may include a trip profile of an upcoming trip of the vehicle 204 (such as information that can be used to control one or more operations of the vehicle 204, including tractive and/or braking efforts provided by the vehicle 108 during the trip), station information (such as the location of a beginning station where the upcoming trip is to begin and/or the location of an ending station where the upcoming trip is to end), restriction information (such as work zone identifications, or information on locations where the route 202 shown in FIG. 2 is being repaired or is near another route 202 being repaired or scheduled to be repaired, and corresponding speed/throttle limitations on the vehicle 204), and/or operating mode information (such as speed/throttle limitations on the vehicle 204 in various locations, slow orders, and the like). At least some of the trip data can come from or be based on allocations generated by other systems, such as the path chosen by the routing module 306 of the scheduling system 220 shown in FIG. 3, the sections of the routes 202 that are under repair or are scheduled to be under repair as selected by the maintenance planning system 230 shown in FIG. 2, and the like.

Vehicle data includes information about the vehicle 204 and/or cargo being carried by the vehicle 204. For example, vehicle data may represent cargo content (such as information representative of cargo being transported by the vehicle 204) and/or vehicle information (such as model numbers, manufacturers, horsepower, and the like, of the vehicle 204). At least some of the vehicle data may come from or be based on allocations generated by the yard planning system 230 (shown in FIG. 2), such as the type of vehicle 204, the vehicles 204 that are included in a larger combined vehicle 204, and the like.

Route data includes information about the routes 202 (shown in FIG. 2) upon which the vehicle 204 is to travel to reach the destination location. For example, the route data can include information about locations of damaged sections of routes 202, locations of sections of the route 202 that are under repair or construction or are scheduled to undergo repair or construction, the curvature and/or grade of sections of the routes 202, geographic coordinates of the routes 202, and the like. At least some of the route data may come from or be based on the allocations generated by the scheduling system 220, such as by the routing module 306 shown in FIG. 3. Additionally or alternatively, at least some of the route data may come from or be based on the allocations generated by the maintenance planning system 230 (shown in FIG. 2), such as the locations and/or times that sections of the routes 202 are under repair or maintenance, or are scheduled to undergo repair or maintenance.

The control system 214 includes a control module 608 that forms control signals based on the trip plan. The control module 608 examines the trip plan generated by the energy management module 604 and determines the settings and/or changes to current settings of the propulsion subsystem 216 that are needed to propel the vehicle 204 as directed by the trip plan. For example, if the trip plan directs the vehicle 204 to slow when cresting a peak in order to reduce fuel consumption and/or generated emissions, the control system 214 may examine the current speed, throttle setting, and/or brake setting of the vehicle 204 and determine if one or more needs to be changed. If the vehicle 204 is traveling faster than directed by the trip plan, the control system 214 may generate control signals that are used to reduce the throttle setting of the motive assembly 600, increase the brake setting of the brake assembly 602, and/or otherwise reduce the speed of the vehicle 204 to the designated speed.

In another embodiment, at least some of the data used to form the trip plan may be received from an operator using an input device 610. For example, a human operator may provide data used to form the trip plan into the control system 214 using a keyboard, microphone, touchscreen, electronic mouse, joystick, or other device.

The control signals may be transmitted to the propulsion subsystem 216 to automatically control the tractive efforts and/or braking efforts provided by the propulsion subsystem 216. Alternatively, the control signals may be transmitted to an output device 612, such as an electronic display, monitor, speaker, tactile device, or other device, that visually, audibly, and/or tactually notifies an operator of the throttle settings, brake settings, and/or changes thereto in accordance with the trip plan.

A feedback module 614 of the control system 214 can determine deviations or differences between the selected allocation of the vehicle 204 (e.g., the trip plan generated by the energy management module 604) and an actual allocation of the vehicle 204 (e.g., the actual movement of the vehicle 204). For example, the feedback module 614 can compare the actual throttle settings, brake settings, and/or speeds used or generated by the propulsion subsystem 216 and compare the settings and/or speeds to the trip plan. Differences between the actual settings and/or speeds and the settings and/or speeds designated by the trip plan can represent differences between the actual allocation and the selected allocation of the control system 214. The actual allocation may differ from the selected allocation for one or more reasons, such as the tractive output from the propulsion subsystem 216 being less than expected, interference with travel of the vehicle 204 (e.g., from other vehicles 204 blocking or slowing movement according to the trip plan), and the like.

As described above, the systems 214, 220, 226, 230 may allocate the resources (e.g., the vehicles 204) differently for movement in the transportation network 200 in order to drive the resources toward different respective goal conditions. The different allocations can result in the selected or designated allocation of a system from differing from the actual allocation of the resources. For example, the trip plan generated by the control system 214 of a vehicle 204 may prevent that vehicle 204 from reaching a scheduled destination location at a scheduled arrival time that is selected by the scheduling system 220. The yard planning system 226 may place vehicles 204 having high priorities as set by the scheduling system 220 in a larger combined vehicle 204 having a low priority in the vehicle yard 218, which can result in the high priority vehicles 204 being unable to get out of the vehicle yard 218 in time to reach scheduled destination locations on time. The scheduling system 220 may schedule several vehicles 204 to travel through a section of the routes 202 that is scheduled to be repaired and/or maintained by the maintenance planning system 230.

The differing allocations of the vehicles 204 may result from the different goal conditions of the systems 214, 220, 226, 230. For example, the control system 214 may have a goal condition that reduces the fuel consumed and/or emissions generated by the vehicle 204 for a trip. On the other hand, the scheduling system 220 may have a goal condition that includes getting the vehicles 204 to scheduled destination locations more quickly than the control system 214 would have the vehicles 204 travel. The yard planning system 226 may arrange and/or build the vehicles 204 in order to allow other vehicles 204 to enter into the vehicle yard 218, to place higher priority vehicles 208 together and the like, which can interfere with the scheduling system 220 attempting to get the vehicles 204 to the destination locations sooner. The maintenance planning system 230 may seek to keep the health of the vehicles 204 and the routes 202 above designated levels, but the scheduling system 220 may seek to continue movement of the vehicles 204 in order to reach the destination locations at or before the scheduled arrival times.

Two or more of the systems 214, 220, 226, 230 may provide feedback data to each other that represents differences between the allocations of the vehicles 204 that are selected by the systems 214, 220, 226, 230 and the actual allocations of the vehicles 204 that occur when the vehicles 204 move in the transportation network 200. For example, the feedback modules 310, 406, 506, 614 may communicate differences between the selected allocations and the actual allocations, as described above, between two or more of the systems 214, 220, 226, 230. The selected allocations of the systems 214, 220, 226, 230 may be selected by the systems 214, 220, 226, 230 to drive the resources 204 toward the goal conditions of the systems 214, 220, 226, 230. For example, the goal condition of the control system 214 in a vehicle 204 may be the travel of the vehicle 204 according to a trip plan, such that the vehicle 204 is located at various locations at corresponding times associated with the trip plan. The trip plan that is generated by the control system 214 may be generated to drive, or cause the vehicle 204 to move, according to the trip plan.

The goal condition of the scheduling system 220 may be the arrival of the vehicles 204 at selected destination locations at associated arrival times. The schedules that are generated by the scheduling system 220 may be created to cause the vehicles 204 to move toward the destination locations at the arrival times. The goal condition of the yard planning system 226 may be a selected arrangement of vehicles 204 in the vehicle yard 218, a combination or coupling of vehicles 204 into a combined vehicle 204, one or more times of departure of the vehicles 204 from the vehicle yard 218, and the like. The yard planning system 226 may direct the vehicles 204 to locations within the vehicle yard 218 and/or out of the vehicle yard 218 at designated times in order to move the vehicles 204 toward the goal condition. The goal condition of the maintenance planning system 230 may be the repair and/or maintenance of the vehicles 204 and/or routes 202 when and where the repairs are needed. The maintenance planning system 230 may schedule the repair or maintenance of the vehicles 204 and/or routes 202 as needed in order to reach the goal condition.

The differences between the actual allocations and the selected allocations can be communicated by the feedback modules 310, 406, 506, 614 between and/or among the systems 214, 220, 226, 230 as feedback data. For example, with respect to the control system 214, the feedback data may include differences in location between where the vehicle 204 actually is located and where the vehicle 204 should be located at the same time according to the trip plan generated by the control system 214. With respect to the scheduling system 220, the feedback data may include differences in location between where the vehicles 204 actually are located and where the vehicles 204 should be located at the same time according to the schedules generated by the control system 214. Additionally or alternatively, the feedback data may include differences in time between when the vehicles 204 are calculated as going to arrive at destination locations (e.g., the ETAs of the vehicles 204) and when the vehicles 204 are scheduled to arrive at the destination locations. With respect to the yard planning system 226, the feedback data may include differences between which vehicles 204 actually are combined with each other and which vehicles 204 that another system, such as the scheduling system 220, requests be combined. Alternatively, the feedback data for the yard planning system 226 can include differences between actual times that a vehicle 204 leaves the vehicle yard 218 and when another system, such as the scheduling system 220, requests that the vehicle 204 leave the vehicle yard 218. The feedback data for the maintenance planning system 230 can include differences between actual times that repair and/or maintenance of a vehicle 204 and/or section of a route 202 begins and the times selected by the maintenance planning system 230 to being the repair and/or maintenance. Alternatively, the feedback data can include differences in locations between where the maintenance planning system 230 selected for the repair of a vehicle 204 to occur and where the actual repair of the vehicle 204 occurred.

One or more of the systems 214, 220, 226, 230 can receive the feedback data from one or more others of the systems 214, 220, 226, 230 and change the allocation of the resources that is selected by the system 214, 220, 226, 230. For example, a first system can receive the feedback data from a second system and, based on the feedback data, change the allocation of the resources that is selected by the first system. Similarly, the second system can receive the feedback data from the first system (and/or one or more other systems) and change the allocation of resources based thereon. The changed allocation of the resources may be a change that drives the resources toward the same or a different goal condition of the first system.

For example, the control system 214 of a vehicle 204 may receive feedback data from the scheduling system 220 that the vehicle 204 is behind schedule (e.g., is not in the position of the schedules created by the scheduling system 220) and feedback data from the maintenance planning system 230 that a section of a route 202 to be traversed by the vehicle 204 is scheduled to be unavailable for repair shortly before the vehicle 204 is to travel over the section of the route 202 (and later than previously scheduled by the maintenance planning system 230). Similarly, the scheduling system 220 may receive feedback data from the control system 214 of the vehicle 204 that the vehicle 204 is traveling according to a trip plan that has the vehicle 204 traveling behind the schedule created by the scheduling system 220 and feedback data from the maintenance planning system 230 regarding when the section of the route 202 will be unavailable. The maintenance planning system 230 can receive feedback data from the control system 214 and/or the scheduling system 220 indicating that the vehicle 204 is traveling behind schedule.

Based on this feedback data, the control system 214 can change the trip plan of the vehicle 204. For example, the control system 214 can change the trip plan so that the vehicle 204 travels faster toward the scheduled destination location in order to try to catch up with the schedule. The scheduling system 220 can modify the schedule of the vehicle 204 so that the vehicle 204 can continue to travel at a slower speed than originally scheduled to arrive at the destination location. The scheduling system 220 may change the schedule of the vehicle 204 so that the vehicle 204 travels around, and not through, the second of the route 202 that is scheduled to go under repair. Similarly, the control system 214 may modify the trip plan based on the changed schedule. The maintenance planning system 230 may modify when the repair of the section of the route 202 is scheduled to take place. Similarly, the control system 214 may change the trip plan and/or the scheduling system 220 may change the schedule of the vehicle 204 based on a change in when the repair of the route 202 is to occur.

Alternatively, one or more of the systems 214, 220, 226, 230 may change the goal conditions of the systems 214, 220, 226, 230 based on the feedback data. For example, the control system 214 may change the goal condition of reducing the fuel consumption or emissions generated by the vehicle 204 to a goal condition that involves getting the vehicle 204 to a destination location at a scheduled time (e.g., to more coincide with the goal condition of the scheduling system 214). The scheduling system 220 may change the goal condition of maintaining a throughput parameter of the transportation network 200 above a first threshold to maintaining the throughput parameter above a lower, second threshold. Other systems may change associated goal conditions as well based on the feedback data.

The systems 214, 220, 226, 230 may continue to allocate resources (e.g., vehicles 204) in the transportation network 200 to drive the resources toward goal conditions of the systems 214, 220, 226, 230, determine differences between the selected allocation of resources and the actual allocation of resources as feedback data, and communicate the feedback data between the systems 214, 220, 226, 230. One or more of the systems 214, 220, 226, 230 can then change the allocations of the resources and/or the goal conditions of the systems 214, 220, 226, 230 based on the feedback data. This feedback loop can continue between the systems 214, 220, 226, 230 to synchronize or harmonize the different allocations and/or goal conditions of the systems 214, 220, 226, 230. The feedback loop can continue as the vehicles 204 travel in the transportation network 200.

In one embodiment, the systems 214, 220, 226, 230 may be associated with priorities to determine which allocation (or reallocation) of resources controls over other conflicting allocation or reallocation of resources. If two or more systems 214, 220, 226, 230 reallocate the resources based on feedback in incompatible ways, then the allocation or reallocation of the system 214, 220, 226, 230 associated with the higher priority can govern and be applied to the resources. As one example, if the scheduling system 220 seeks to reallocate the vehicles 204 by speeding up movement of the vehicles 204 such that one or more vehicles 204 travel over a section of a route 202 to be repaired, and the maintenance planning system 230 seeks to reallocate when a section of the route 202 will be repaired to the same time that one or more of the vehicles 204 is reallocated to travel over the same section of the route 202, then the priorities associated between the scheduling system 220 and the maintenance planning system 230 may control which reallocation is used and which is ignored.

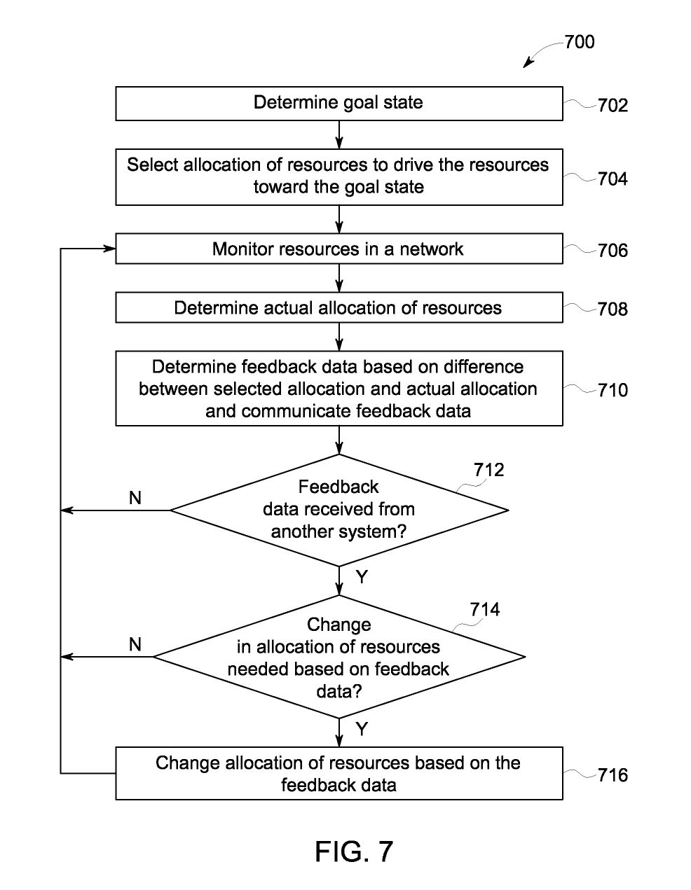

FIG. 7 is a flowchart of one embodiment of a method 700 for allocating resources in a network. The method 700 may be used in conjunction with one or more embodiments described herein, such as with the transportation network 200 shown in FIG. 2. For example, the method 700 may be used to harmonize competing goal conditions of different systems that are trying to differently allocate the same resources of the network to reach different goal conditions.

At 702, a goal condition is determined. For example, goal conditions for one or more of the systems 214, 220, 226, 230 (shown in FIG. 2) may be determined. The scheduling system 220 may have a goal condition of getting several vehicles 204 (shown in FIG. 2) to associated destination locations in a designated order and/or in a relatively short amount of time. The control system 214 may have a goal condition of getting a vehicle 204 to a destination location using less fuel and/or while generating fewer emissions relative to traveling to the destination location in another manner. The yard planning system 226 may have a goal condition of grouping or coupling the vehicles 204 into larger combined vehicles 204 based on priorities of the vehicles 204 and/or the destination locations of the vehicles 204 (e.g., by grouping together the vehicles 204 having the same or relatively close destination locations). The maintenance planning system 230 may have a goal condition of repairing and/or maintaining the vehicles 204 and routes 202 (shown in FIG. 2) when the vehicles 204 and routes 202 need the repair or maintenance.

At 704, an allocation of resources is selected to drive the resources toward the goal condition. For example, the control system 214 (shown in FIG. 2) may allocate movement of the vehicle 204 (shown in FIG. 2) according to a trip plan as described above. The scheduling system 220 (shown in FIG. 2) may create schedules that direct the vehicles 204 to travel to the destination locations of the vehicles 204. The yard planning system 226 (shown in FIG. 2) may select vehicles 204 for grouping together and/or for arranging in the vehicle yard 218 (shown in FIG. 2), as described above. The maintenance planning system 230 (shown in FIG. 2) may determine when a vehicle 204 and/or section of a route 202 (shown in FIG. 2) is to be serviced for repair and/or maintenance, as described above.

At 706, the resources in the network are monitored. For example, the movement of the vehicles 204 (shown in FIG. 2) in the transportation network 200 (shown in FIG. 2) is monitored. The vehicles 204 move according to the allocations of one or more of the systems 214, 220, 226, 230 (shown in FIG. 2).

At 708, the actual allocation of the resources is determined. As described above, because the vehicles 204 (shown in FIG. 2) may move according to different allocations provided by different systems 214, 220, 226, 230 (shown in FIG. 2), the actual movement of the vehicles 204 may not correspond to the selected allocations of one or more of the systems 214, 220, 226, 230. In one embodiment, the actual allocations of the vehicles 204 may be monitored as the locations and associated times of the vehicles 204 as the vehicles 204 move in the transportation network 200 (shown in FIG. 2).

At 710, feedback data is determined from the difference between the actual allocation and the selected allocation for one or more of the systems 214, 220, 226, 230 (shown in FIG. 2). The feedback data may include or represent the difference between scheduled or planned locations of the vehicles 204 (shown in FIG. 2) and actual locations of the vehicles 204, the difference between scheduled and actual groupings of the vehicles 204 into combined vehicles 204, the difference between scheduled and actual services for repair or maintenance to the vehicles 204 and/or sections of the routes 202 (shown in FIG. 2), and the like. The feedback data can be communicated to one or more of the other systems 214, 220, 226, 230 so that the systems 214, 220, 226, 230 can share the feedback data.

At 712, a determination is made as to whether feedback data is received from another system. For example, the control system 214 (shown in FIG. 2) may determine if feedback data from the scheduling system 220, the yard planning system 226, and/or the maintenance planning system 230 (shown in FIG. 2) is received. Alternatively, one or more other systems 220, 226, 230 may determine if feedback data is received from another system 214, 220, 226, 230. With respect to a first system, if feedback data is received from a different, second system, then the selected allocation of the resources by the first system may need to be modified in order to drive the resources toward the goal condition of the first system and/or the goal condition of the first system may need to be modified. As a result, flow of the method 700 may proceed to 714. On the other hand, if no other system provides feedback data, then the selected allocation and/or goal condition may not need to be changed and the flow of the method 700 may return to 706, where the resources continue to be monitored in the network.

At 714, a determination is made as to whether the feedback data indicates that the selected allocation of resources by a system 214, 220, 226, 230 (shown in FIG. 2) may need to be changed. Alternatively, a determination may be made as to whether the feedback data indicates that the goal condition of the system 214, 220, 226, 230 may need to be changed. With respect to a first system, if the feedback data from one or more of the other systems 214, 220, 226, 230 indicates that the actual allocation of the vehicles 204 (shown in FIG. 2) differs from the selected allocation for the one or more other systems 214, 220, 226, 230, then the selected allocation and/or goal condition of the first system may need to be changed. For example, if the differences between the scheduled arrival times created by the scheduling system 214 for the vehicles 204 and the ETAs for the vehicles 204 exceed one or more thresholds, then the control systems 214 for one or more vehicles 204 may need to change the trip plans for the vehicles 204 (e.g., to speed up movement of the vehicles 204). As another example, if the differences between the actual locations of the vehicles 204 and the locations designated by trip plans of the control systems 214 exceed one or more thresholds, then the scheduling system 214 may need to change the schedules for one or more of the vehicles 204. As a result, flow of the method 700 proceeds to 716. Otherwise, the flow of the method 700 may return to 706, where the resources continued to be monitored.

At 716, the allocation of resources is changed based on the feedback data. For example, the control systems 214 (shown in FIG. 2) for one or more vehicles 204 (shown in FIG. 2) may change the trip plans for the vehicles 204 in order to speed up movement of the vehicles 204. As another example, the scheduling system 214 may change the scheduled arrival times for the vehicles 204 and/or change the routes 202 (shown in FIG. 2) taken by the vehicles 204. The allocation of the vehicles 204 may be changed in order to harmonize the goal condition of a first system with a second system, such as by assisting the second system in achieving a goal condition. Alternatively, the goal condition of a first system may be changed in order to harmonize the goal condition of the first system with the goal condition of a second system. For example, instead of trying to maintain the throughput parameter of the transportation network 200 (shown in FIG. 2) above a first threshold, the scheduling system 214 may attempt to maintain the throughput parameter above a lower, second threshold. In one embodiment, a system may change the allocation of the resources by changing which algorithm is used to allocate the resources. As described above, different systems may use different algorithms that apply different priorities in allocating the resources. As a result, use of different algorithms may result in different priorities being applied to allocating the resources.

The flow of the method 700 may return to 706, where the resources continue to be monitored. For example, continued movement of the vehicles 204 (shown in FIG. 2) may be monitored to repeatedly determine if the allocations and/or goal conditions need to be modified. Repeated determination if the allocations of the resources and/or goal conditions need to be modified can assist the different systems 214, 220, 226, 230 (shown in FIG. 2) in harmonizing the different goal conditions and may reduce competition between the different systems in allocating the same resources.

In another embodiment, a system is provided that includes a first allocation unit and a second allocation unit. The first allocation unit is configured to allocate resources in a network according to a first selected allocation for driving the resources in the network toward a first goal condition of the first allocation unit. The second allocation unit is configured to allocate one or more of the resources in the network according to a different, second selected allocation for driving the one or more of the resources toward a different, second goal condition of the second allocation unit. At least one of the first allocation unit or the second allocation unit is configured to generate and provide feedback data to the other of the first allocation unit or the second allocation unit. The feedback data represents a difference between an actual allocation of the one or more resources and the corresponding first selected allocation or the second selected allocation. At least one of the first allocation unit or the second allocation unit is configured to change the first selected allocation or the second selected allocation to change how the resources are allocated in the network based on the feedback data.

In another aspect, the difference between the actual allocation and the first selected allocation or the second selected allocation of the corresponding first allocation unit or the second allocation unit is caused by the other of the first selected allocation or the second selected allocation.

In another aspect, at least one of the first allocation unit or the second allocation unit includes one or more of a scheduling system configured to schedule movement of vehicles in a transportation network, an energy management system configured to determine a trip plan that directs movement of one or more of the vehicles to reduce at least one of fuel consumed by the one or more vehicles or emissions generated by the one or more vehicles while traveling in the transportation network, a yard planning system configured to at least one of arrange or combine the vehicles in a vehicle yard of the transportation network, or a maintenance planning system configured to schedule at least one of repair or maintenance for at least one of the vehicles or sections of routes in the transportation network.

In another aspect, at least one of the first selected allocation or the second selected allocation includes scheduled movements of one or more of the vehicles that are generated by the scheduling system and the actual allocation includes actual movements of the one or more of the vehicles.

In another aspect, at least one of the first selected allocation or the second selected allocation includes selected movement of the one or more vehicles according to the trip plan and the actual allocation includes actual movement of the one or more vehicles.

In another aspect, at least one of the first selected allocation or the second selected allocation includes at least one of a selected arrangement or a selected combination of a first plurality of the vehicles into a vehicle consist and the actual allocation includes at least one of an actual arrangement or an actual combination of a second plurality of the vehicles into the vehicle consist.

In another aspect, at least one of the first selected allocation or the second selected allocation includes at least one of a scheduled time or a scheduled location for the at least one of repair or maintenance of the at least one of the vehicles or sections of routes, and the actual allocation includes at least one of an actual time or an actual location for the at least one of repair or maintenance of the at least one of the vehicles or sections of routes.

In another aspect, the scheduling system is configured to change at least one of a scheduled arrival time or a scheduled destination location for one or more of the vehicles based on the feedback data received from at least one of the control system, the yard planning system, or the maintenance planning system.

In another aspect, the control system is configured to change the trip plan for one or more of the vehicles based on the feedback data received from at least one of the scheduling system, the yard planning system, or the maintenance planning system.

In another aspect, the yard planning system is configured to change at least one of the arrangement or the combination of the vehicles based on the feedback data received from at least one of the scheduling system, the control system, or the maintenance planning system.

In another aspect, the maintenance planning system is configured to change the at least one of repair or maintenance for the at least one of the vehicles or sections of routes in the transportation network based on the feedback data received from at least one of the scheduling system, the control system, or the yard planning system.

In another aspect, at least one of the first goal condition or the second goal condition includes at least one of: maintaining a throughput parameter of the transportation network above a first designated, non-zero threshold, moving the vehicles to scheduled destination locations at or before associated scheduled arrival times, or reducing the at least one of fuel consumed or emissions generated by the one or more vehicles below a second designated threshold. The throughput parameter represents flow of movement of the vehicles in the transportation network.

In another embodiment, a method is provided that includes allocating resources in a network (e.g., transportation network) according to a first selected allocation for driving (i.e., that drives) the resources in the network toward a first goal condition, allocating one or more of the resources in the network according to a different, second selected allocation for driving (i.e., that drives) the one or more of the resources toward a different, second goal condition, and generating feedback data representative of a difference between an actual allocation of the one or more resources and the corresponding first selected allocation or the second selected allocation. The method also includes changing the first selected allocation or the second selected allocation of the resources in the network based on the feedback data.

In another aspect, the difference between the actual allocation and the first selected allocation or the second selected allocation is caused by the other of the first selected allocation or the second selected allocation.

In another aspect, at least one of allocating the resources according to the first selected allocation or allocating the resources according to the second selected allocation includes: scheduling movement of vehicles in a transportation network, determining a trip plan that directs movement of one or more of the vehicles to reduce at least one of fuel consumed by the one or more vehicles or emissions generated by the one or more vehicles while traveling in the transportation network, at least one of arranging or combining the vehicles in a vehicle yard of the transportation network, or scheduling at least one of repair or maintenance for at least one of the vehicles or sections of routes in the transportation network.

In another aspect, generating the feedback data includes at least one of determining the difference between a scheduled movement of one or more of the vehicles and an actual movement of the one or more of the vehicles, determining the difference between a selected movement of the one or more vehicles according to the trip plan and the actual movement of the one or more vehicles, determining the difference between at least one of a selected arrangement or a selected combination of a first plurality of the vehicles into a vehicle consist and at least one of an actual arrangement or an actual combination of a second plurality of the vehicles into the vehicle consist, or determining the difference between at least one of a scheduled time or a scheduled location for the at least one of repair or maintenance of the at least one of the vehicles or sections of routes and at least one of an actual time or an actual location for the at least one of repair or maintenance of the at least one of the vehicles or sections of routes.

In another aspect, changing the first selected allocation or the second selected allocation of the resources includes at least one of changing at least one of a scheduled arrival time or a scheduled destination location for one or more of the vehicles based on the feedback data, changing the trip plan for one or more of the vehicles so that the one or more of the vehicles consume more fuel or generate more emissions relative to the trip plan prior to changing the trip plan based on the feedback data, changing at least one of the arrangement or the combination of the vehicles based on the feedback data, or changing the at least one of repair or maintenance for the at least one of the vehicles or sections of routes in the transportation network based on the feedback data.

In another aspect, at least one of the first goal condition or the second goal condition includes at least one of maintaining a throughput parameter of the transportation network above a first designated, non-zero threshold, moving the vehicles to scheduled destination locations at or before associated scheduled arrival times, or reducing the at least one of fuel consumed or emissions generated by the one or more vehicles below a second designated threshold. The throughput parameter represents flow of movement of the vehicles in the transportation network.

Another embodiment includes a system having a first allocation unit configured to allocate resources in a network according to a first selected allocation for driving the resources in the network toward a first goal condition of the first allocation unit. The first allocation unit is configured to receive feedback data from a second allocation unit that is configured to allocate at least some of the resources in the network according to a different, second selected allocation for driving the at least some of the resources toward a different, second goal condition. The feedback data is representative of a difference between an actual allocation of the at least some of the resources and the second selected allocation. The first allocation unit also is configured to change at least one of the first selected allocation or the first goal condition based on the feedback data.

In another aspect, the difference between the actual allocation and the second selected allocation is caused by the first selected allocation of the first allocation unit.

In another aspect, at least one of the first allocation unit or the second allocation unit includes one or more of a scheduling system configured to schedule movement of vehicles in a transportation network, an energy management system configured to determine a trip plan that directs movement of one or more of the vehicles to reduce at least one of fuel consumed by the one or more vehicles or emissions generated by the one or more vehicles while traveling in the transportation network, a yard planning system configured to at least one of arrange or combine the vehicles in a vehicle yard of the transportation network, or a maintenance planning system configured to schedule at least one of repair or maintenance for at least one of the vehicles or sections of routes in the transportation network.

In another aspect, the feedback data includes at least one of the difference between scheduled movements of one or more of the vehicles that are generated by the scheduling system and actual movements of the one or more of the vehicles, the difference between selected movement of the one or more vehicles according to the trip plan and actual movement of the one or more vehicles, the difference between at least one of a selected arrangement or a selected combination of a first plurality of the vehicles into a vehicle consist and at least one of an actual arrangement or an actual combination of a second plurality of the vehicles into the vehicle consist, or the difference between at least one of a scheduled time or a scheduled location for the at least one of repair or maintenance of the at least one of the vehicles or sections of routes and at least one of an actual time or an actual location for the at least one of repair or maintenance of the at least one of the vehicles or sections of routes.

In another aspect, the first allocation unit is configured to change at least one of a scheduled arrival time or a scheduled destination location for one or more of the vehicles based on the feedback data received from the second allocation unit, the trip plan for one or more of the vehicles based on the feedback data received from the second allocation unit, the arrangement or the combination of the vehicles based on the feedback data received from the second allocation unit, or the at least one of repair or maintenance for the at least one of the vehicles or sections of routes in the transportation network based on the feedback data received from the second allocation unit.

In another aspect, at least one of the first goal condition or the second goal condition includes at least one of maintaining a throughput parameter of the transportation network above a first designated, non-zero threshold, moving the vehicles to scheduled destination locations at or before associated scheduled arrival times, or reducing the at least one of fuel consumed or emissions generated by the one or more vehicles below a second designated threshold. The throughput parameter represents flow of movement of the vehicles in the transportation network.

In another embodiment, a system comprises a first allocation unit configured to allocate resources in a transportation network according to a first allocation. The first allocation unit is further configured to select the first allocation in order to drive the resources in the network toward a first goal condition of the first allocation unit. The first allocation unit is further configured to receive feedback data from a second allocation unit that is configured to allocate at least some of the resources in the network according to a different, second allocation. The second allocation is selected by the second allocation unit in order to drive the at least some of the resources toward a different, second goal condition. The feedback data is representative of a difference between an actual allocation of the at least some of the resources and the second allocation. The first allocation unit is configured to change at least one of the first selected allocation or the first goal condition based on the feedback data.

In another embodiment, a system comprises a first allocation unit configured to allocate resources in a transportation network according to a first allocation. The first allocation is selected for driving the resources in the network toward a first goal condition of the first allocation unit, that is, allocating the resources according to the first selected allocation drives the resources towards the first goal condition. The system further comprises a second allocation unit configured to allocate one or more of the resources in the network according to a different, second allocation. The second allocation is selected for driving the one or more of the resources toward a different, second goal condition of the second allocation unit. That is, allocating the one or more of the resources according to the different second allocation drives the one or more of the resources toward the second goal condition. At least one of the first allocation unit or the second allocation unit is configured to generate and provide feedback data to the other of the first allocation unit or the second allocation unit. The feedback data is representative of a difference between an actual allocation of the one or more resources and the corresponding first selected allocation or the second selected allocation. Further, at least one of the first allocation unit or the second allocation unit is configured to change the first selected allocation or the second selected allocation, based on the feedback data, to modify (change) how the resources are allocated in the network.

In another embodiment of the system, at least one of the first allocation unit or the second allocation unit includes a scheduling system configured to schedule movement of vehicles in the transportation network. Further, at least one of the first selected allocation or the second selected allocation includes scheduled movements of one or more of the vehicles that are generated by the scheduling system and the actual allocation includes actual movements of the one or more of the vehicles.

In another embodiment of the system, at least one of the first allocation unit or the second allocation unit includes an energy management system configured to determine a trip plan that directs movement of one or more of plural vehicles in the transportation network to reduce at least one of fuel consumed by the one or more vehicles or emissions generated by the one or more vehicles while traveling in the transportation network. Further, at least one of the first selected allocation or the second selected allocation includes selected movement of the one or more vehicles according to the trip plan and the actual allocation includes actual movement of the one or more vehicles.

In another embodiment of the system, at least one of the first allocation unit or the second allocation unit includes a yard planning system configured to at least one of arrange or combine the vehicles in a vehicle yard of the transportation network. Further, at least one of the first selected allocation or the second selected allocation includes at least one of a selected arrangement or a selected combination of a first plurality of the vehicles into a vehicle consist and the actual allocation includes at least one of an actual arrangement or an actual combination of a second plurality of the vehicles into the vehicle consist.

In another embodiment of the system, at least one of the first allocation unit or the second allocation unit includes a maintenance planning system configured to schedule at least one of repair or maintenance for at least one of the vehicles or sections of routes in the transportation network. Further, at least one of the first selected allocation or the second selected allocation includes at least one of a scheduled time or a scheduled location for the at least one of repair or maintenance of the at least one of the vehicles or sections of routes, and the actual allocation includes at least one of an actual time or an actual location for the at least one of repair or maintenance of the at least one of the vehicles or sections of routes.

Another embodiment relates to a system comprising a first allocation unit configured to allocate resources in a transportation network according to a first selected allocation for driving the resources in the network toward a first goal condition of the first allocation unit. The system additionally comprises a second allocation unit configured to allocate the resources in the network according to a different, second selected allocation for driving the resources toward a different, second goal condition of the second allocation unit. The first allocation unit is configured to generate and provide feedback data to the second allocation unit. The feedback data is representative of a difference between an actual allocation of the resources and the first selected allocation. The second allocation unit is configured to revise the second selected allocation to change how the resources are allocated in the network, based on the feedback data.

In another embodiment, a method comprises allocating resources in a transportation network according to a first selected allocation, for driving the resources in the network toward a first goal condition. The method further comprises allocating the resources in the network according to a different, second selected allocation, for driving the resources toward a different, second goal condition. The method further comprises generating feedback data representative of a difference between an actual allocation of the resources and the first selected allocation. The method further comprises changing the second selected allocation of the resources in the network based on the feedback data.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the inventive subject matter, including the best mode, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

What is claimed is:

1. A system comprising:
a first allocation unit configured to allocate resources in a network according to a first selected allocation for driving the resources in the network toward a first goal condition of the first allocation unit; and
a second allocation unit configured to allocate one or more of the resources in the network according to a different, second selected allocation for driving the one or more of the resources toward a different, second goal condition of the second allocation unit,
wherein at least one of the first allocation unit or the second allocation unit is configured to generate and provide feedback data to the other of the first allocation unit or the second allocation unit, the feedback data representative of a difference between an actual allocation of the one or more resources and the corresponding first selected allocation or the second selected allocation, and
wherein at least one of the first allocation unit or the second allocation unit is configured to change the first selected allocation or the second selected allocation to change how the resources are allocated in the network based on the feedback data.

2. The system of claim 1, wherein the difference between the actual allocation and the first selected allocation or the second selected allocation of the corresponding first allocation unit or the second allocation unit is caused by the other of the first selected allocation or the second selected allocation.

3. The system of claim 1, wherein at least one of the first allocation unit or the second allocation unit includes one or more of a scheduling system configured to schedule movement of vehicles in a transportation network, an energy management system configured to determine a trip plan that directs movement of one or more of the vehicles to reduce at least one of fuel consumed by the one or more vehicles or emissions generated by the one or more vehicles while traveling in the transportation network, a yard planning system configured to at least one of arrange or combine the vehicles in a vehicle yard of the transportation network, or a maintenance planning system configured to schedule at least one of repair or maintenance for at least one of the vehicles or sections of routes in the transportation network.

4. The system of claim 3, wherein at least one of the first selected allocation or the second selected allocation includes scheduled movements of one or more of the vehicles that are generated by the scheduling system and the actual allocation includes actual movements of the one or more of the vehicles.

5. The system of claim 3, wherein at least one of the first selected allocation or the second selected allocation includes selected movement of the one or more vehicles according to the trip plan and the actual allocation includes actual movement of the one or more vehicles.

6. The system of claim 3, wherein at least one of the first selected allocation or the second selected allocation includes at least one of a selected arrangement or a selected combination of a first plurality of the vehicles into a vehicle consist and the actual allocation includes at least one of an actual arrangement or an actual combination of a second plurality of the vehicles into the vehicle consist.

7. The system of claim 3, wherein at least one of the first selected allocation or the second selected allocation includes at least one of a scheduled time or a scheduled location for the at least one of repair or maintenance of the at least one of the vehicles or sections of routes, and the actual allocation includes at least one of an actual time or an actual location for the at least one of repair or maintenance of the at least one of the vehicles or sections of routes.

8. The system of claim 3, wherein the scheduling system is configured to change at least one of a scheduled arrival time or a scheduled destination location for one or more of the vehicles based on the feedback data, which is received from at least one of the energy management system, the yard planning system, or the maintenance planning system.

9. The system of claim 3, wherein the energy management system is configured to change the trip plan for one or more of the vehicles based on the feedback data, which is received from at least one of the scheduling system, the yard planning system, or the maintenance planning system.

10. The system of claim 3, wherein the yard planning system is configured to change at least one of the arrangement or the combination of the vehicles based on the feedback data, which is received from at least one of the scheduling system, the energy management system, or the maintenance planning system.

11. The system of claim 3, wherein the maintenance planning system is configured to change the at least one of repair or maintenance for the at least one of the vehicles or sections of routes in the transportation network based on the feedback data, which is received from at least one of the scheduling system, the energy management system, or the yard planning system.

12. The system of claim 3, wherein at least one of the first goal condition or the second goal condition includes at least one of:
maintaining a throughput parameter of the transportation network above a first designated, non-zero threshold, wherein the throughput parameter represents flow of movement of the vehicles in the transportation network;
moving the vehicles to scheduled destination locations at or before associated scheduled arrival times; or
reducing the at least one of fuel consumed or emissions generated by the one or more vehicles below a second designated threshold.

13. A method comprising:
allocating resources in a network according to a first selected allocation for driving the resources in the network toward a first goal condition;
allocating one or more of the resources in the network according to a different, second selected allocation for driving the one or more of the resources toward a different, second goal condition;
generating feedback data representative of a difference between an actual allocation of the one or more resources and the corresponding first selected allocation or the second selected allocation; and
changing the first selected allocation or the second selected allocation of the resources in the network based on the feedback data.

14. The method of claim 13, wherein the difference between the actual allocation and the first selected allocation or the second selected allocation is caused by the other of the first selected allocation or the second selected allocation.

15. The method of claim 13, wherein at least one of allocating the resources according to the first selected allocation or allocating the resources according to the second selected allocation includes:
scheduling movement of vehicles in a transportation network;
determining a trip plan that directs movement of one or more of the vehicles to reduce at least one of fuel consumed by the one or more vehicles or emissions generated by the one or more vehicles while traveling in the transportation network;
at least one of arranging or combining the vehicles in a vehicle yard of the transportation network; or
scheduling at least one of repair or maintenance for at least one of the vehicles or sections of routes in the transportation network.

16. The method of claim 15, wherein generating the feedback data includes at least one of:
determining the difference between a scheduled movement of one or more of the vehicles and an actual movement of the one or more of the vehicles;
determining the difference between a selected movement of the one or more vehicles according to the trip plan and the actual movement of the one or more vehicles;
determining the difference between at least one of a selected arrangement or a selected combination of a first plurality of the vehicles into a vehicle consist and at least one of an actual arrangement or an actual combination of a second plurality of the vehicles into the vehicle consist; or
determining the difference between at least one of a scheduled time or a scheduled location for the at least one of repair or maintenance of the at least one of the vehicles or sections of routes and at least one of an actual time or an actual location for the at least one of repair or maintenance of the at least one of the vehicles or sections of routes.

17. The method of claim 15, wherein changing the first selected allocation or the second selected allocation of the resources includes at least one of:
changing at least one of a scheduled arrival time or a scheduled destination location for one or more of the vehicles based on the feedback data;
changing the trip plan for one or more of the vehicles so that the one or more of the vehicles consume more fuel or generate more emissions relative to the trip plan prior to changing the trip plan based on the feedback data;
changing at least one of the arrangement or the combination of the vehicles based on the feedback data; or
changing the at least one of repair or maintenance for the at least one of the vehicles or sections of routes in the transportation network based on the feedback data.

18. The method of claim 15, wherein at least one of the first goal condition or the second goal condition includes at least one of:
maintaining a throughput parameter of the transportation network above a first designated, non-zero threshold, wherein the throughput parameter represents flow of movement of the vehicles in the transportation network;
moving the vehicles to scheduled destination locations at or before associated scheduled arrival times; or
reducing the at least one of fuel consumed or emissions generated by the one or more vehicles below a second designated threshold.

19. A system comprising:
a first allocation unit configured to allocate resources in a network according to a first selected allocation for driving the resources in the network toward a first goal condition of the first allocation unit;
wherein the first allocation unit is configured to receive feedback data from a second allocation unit that is configured to allocate at least some of the resources in the network according to a different, second selected allocation for driving the at least some of the resources toward a different, second goal condition, the feedback data being representative of a difference between an actual allocation of the at least some of the resources and the second selected allocation,
wherein the first allocation unit is configured to change at least one of the first selected allocation or the first goal condition based on the feedback data.

20. The system of claim 19, wherein the difference between the actual allocation and the second selected allocation is caused by the first selected allocation of the first allocation unit.

21. The system of claim 19, wherein at least one of the first allocation unit or the second allocation unit includes one or more of a scheduling system configured to schedule movement of vehicles in a transportation network, an energy management system configured to determine a trip plan that directs movement of one or more of the vehicles to reduce at least one of fuel consumed by the one or more vehicles or emissions generated by the one or more vehicles while traveling in the transportation network, a yard planning system configured to at least one of arrange or combine the vehicles in a vehicle yard of the transportation network, or a maintenance planning system configured to schedule at least one of repair or maintenance for at least one of the vehicles or sections of routes in the transportation network.

22. The system of claim 21, wherein the feedback data includes at least one of:
the difference between scheduled movements of one or more of the vehicles that are generated by the scheduling system and actual movements of the one or more of the vehicles;
the difference between selected movement of the one or more vehicles according to the trip plan and actual movement of the one or more vehicles;
the difference between at least one of a selected arrangement or a selected combination of a first plurality of the vehicles into a vehicle consist and at least one of an actual arrangement or an actual combination of a second plurality of the vehicles into the vehicle consist; or
the difference between at least one of a scheduled time or a scheduled location for the at least one of repair or maintenance of the at least one of the vehicles or sections of routes and at least one of an actual time or an actual location for the at least one of repair or maintenance of the at least one of the vehicles or sections of routes.

23. The system of claim 21, wherein the first allocation unit is configured to change at least one of:
a scheduled arrival time or a scheduled destination location for one or more of the vehicles based on the feedback data received from the second allocation unit;
the trip plan for one or more of the vehicles based on the feedback data received from the second allocation unit;
the arrangement or the combination of the vehicles based on the feedback data received from the second allocation unit; or
the at least one of repair or maintenance for the at least one of the vehicles or sections of routes in the transportation network based on the feedback data received from the second allocation unit.

24. The system of claim 21, wherein at least one of the first goal condition or the second goal condition includes at least one of:
maintaining a throughput parameter of the transportation network above a first designated, non-zero threshold, wherein the throughput parameter represents flow of movement of the vehicles in the transportation network;
moving the vehicles to scheduled destination locations at or before associated scheduled arrival times; or
reducing the at least one of fuel consumed or emissions generated by the one or more vehicles below a second designated threshold.

25. A system comprising:
a first allocation unit configured to allocate resources in a transportation network according to a first selected allocation for driving the resources in the network toward a first goal condition of the first allocation unit; and
a second allocation unit configured to allocate the resources in the network according to a different, second selected allocation for driving the resources toward a different, second goal condition of the second allocation unit,
wherein the first allocation unit is configured to generate and provide feedback data to the second allocation unit, the feedback data representative of a difference between an actual allocation of the resources and the first selected allocation, and
wherein the second allocation unit is configured to revise the second selected allocation to change how the resources are allocated in the network based on the feedback data.
